(19) United States
(12) Patent Application Publication
(10) Pub. No.: US 2018/0050266 A1
(43) Pub. Date: Feb. 22, 2018

(54) PROGRAM, ARTICLE SELECTION SYSTEM, TERMINAL DEVICE AND ARTICLE SELECTION METHOD

(71) Applicant: SQUARE ENIX CO., LTD., Tokyo (JP)

(72) Inventors: Hiroshi MINAGAWA, Tokyo (JP); Teppei TAKEDA, Tokyo (JP)

(73) Assignee: SQUARE ENIX CO., LTD., Tokyo (JP)

(21) Appl. No.: 15/676,036

(22) Filed: Aug. 14, 2017

(30) Foreign Application Priority Data
Aug. 16, 2016 (JP) 2016-159469

(51) Int. Cl. A63F 13/24; A63F 13/428; G05G 9/047

(52) U.S. Cl. CPC A63F 13/24; A63F 2300/1043; G05G 9/047; A63F 13/428

(57) ABSTRACT

Provided is a program causing a computer to realize a function of receiving operation information of an operation unit, the program causing the computer to execute a display control function of displaying a plurality of articles, which are disposed along a predetermined direction with respect to a reference position, on the display unit, a direction determination function of determining an indicating direction indicating the one article from the reference position, on the basis of a tilting direction of the operation unit in a case where an amount of tilting is less than the predetermined threshold value, a correction function of determining an amount of correction in a case where the amount of tilting is equal to or greater than the predetermined threshold value, and performing at least one of correction of the indicating direction and correction to shift positions of the plurality of articles.

### BACKGROUND OF THE INVENTION

### 1. Field of the Invention

At least one embodiment of the present invention relates to a program (software) and the like for causing a computer to realize a function of receiving operation information of an operation unit capable of being tilted in any direction and selecting one article from among a plurality of articles displayed on a display unit on the basis of the operation information.

### 2. Description of Related Art

Video games include a match game in which a user operates a player object so as to fight an enemy object, and the like. For example, the user selects a desired command in a menu displayed on a game screen by operating a game pad (operation unit) to thereby cause the player object to perform a motion (attack or the like) corresponding to the selected command.

As graphical user interfaces (GUI) for selecting one article in a menu including a plurality of articles such as commands, various configurations have been proposed (see, for example, JP-A-2002-229697). JP-A-2002-229697 discloses a configuration in which a circular window (menu) sectioned into a plurality of regions along the circumferential direction is displayed on a screen. One article is associated with each of the regions. A user tilts a joystick (operation unit) to thereby select one article associated with a region corresponding to the tilting direction of the joystick.

### SUMMARY OF THE INVENTION

In the above-described configuration in which an article is selected on the basis of the tilting direction of the joystick, the number of regions of the circular window is set in accordance with the number of articles to be displayed (selectable). Therefore, as the number of articles increases, the number of regions also increases, and thus the width (length in the circumferential direction) of one region is reduced. For this reason, it is necessary to align the tilting direction with the region of which the width is reduced, and thus there is a problem in that the tilting operation of the joystick for selecting one article becomes severe.

An object of at least one embodiment of the present invention is to solve the above-described problem and to provide a function of improving user operability in selecting an article using a tilting operation of an operation unit.

From the non-limiting viewpoint, according to an aspect of the present invention, there is provided a program causing a computer to realize a function of receiving operation information of an operation unit tilted in any direction and selecting one article from among a plurality of articles displayed on a display unit on the basis of the operation information, the program causing the computer to execute a display control function of displaying the plurality of articles, which are disposed along a predetermined direction with respect to a reference position in a screen coordinate system of the display unit, on the display unit, a direction determination function of determining an indicating direction indicating the one article from the reference position, on the basis of a tilting direction of the operation unit which is included in the operation information in a case where an amount of tilting of the operation unit which is included in the operation information is less than the predetermined threshold value, a correction function of determining an amount of correction on the basis of an amount of change in the tilting direction based on the tilting direction at a time of the determination of the indicating direction in a case where the amount of tilting is equal to or greater than the predetermined threshold value, and performing at least one of correction of the indicating direction and correction to shift arrangement positions of the plurality of articles along the predetermined direction in accordance with the amount of correction, and a selection function of selecting an article indicated by the indicating direction in a case where the amount of tilting is equal to or greater than the predetermined threshold value.

From the non-limiting viewpoint, according to another aspect of the present invention, there is provided a program causing a server device to select one article from among a plurality of articles displayed on a display unit of a terminal device on the basis of operation information of an operation unit tilted in any direction, the server device being connected to the terminal device receiving the operation information through a communication network, the program causing the server device to execute a display control function of displaying the plurality of articles, which are disposed along a predetermined direction with respect to a reference position in a screen coordinate system of the display unit, on the display unit, a direction determination function of determining an indicating direction indicating the one article from the reference position, on the basis of a tilting direction of the operation unit which is included in the operation information in a case where an amount of tilting of the operation unit which is included in the operation information is less than the predetermined threshold value, a correction function of determining an amount of correction on the basis of an amount of change in the tilting direction based on the tilting direction at a time of the determination of the indicating direction in a case where the amount of tilting is equal to or greater than the predetermined threshold value, and performing at least one of correction of the indicating direction and correction to shift arrangement positions of the plurality of articles along the predetermined direction in accordance with the amount of correction, and a selection function of selecting an article indicated by the indicating direction in a case where the amount of tilting is equal to or greater than the predetermined threshold value.

From the non-limiting viewpoint, according to still another aspect of the present invention, there is provided an article selection system including a game terminal device that receives operation information of an operation unit tilted in any direction and a server device, connected to the game terminal device through a communication network, which selects one article from among a plurality of articles displayed on a display unit of the game terminal device on the basis of the operation information, the article selection system including a display control unit that displays the plurality of articles, which are disposed along a predetermined direction with respect to a reference position in a screen coordinate system of the display unit, on the display unit, a direction determination unit that determines an indicating direction indicating the one article from the reference position, on the basis of a tilting direction of the operation unit which is included in the operation information in a case where an amount of tilting of the operation unit which is included in the operation information is less than the predetermined threshold value, a correction unit that determines an amount of correction on the basis of an amount of change in the tilting direction based on the tilting direction at a time of the determination of the indicating direction in a case where the amount of tilting is equal to or greater than the predetermined threshold value, and performing at least one of correction of the indicating direction and correction to shift arrangement positions of the plurality of articles along the predetermined direction in accordance with the amount of correction, and a selection unit that selects an article indicated by the indicating direction in a case where the amount of tilting is equal to or greater than the predetermined threshold value.

One or two or more deficiencies are solved by embodiments of the present application.

### BRIEF DESCRIPTION OF THE DRAWINGS

FIG. 1 is a block diagram illustrating an example of a configuration of an article selection processing system corresponding to at least one embodiment of the present invention.

FIG. 2 is a functional block diagram illustrating a configuration of a user terminal corresponding to at least one embodiment of the present invention.

FIG. 3 is a flow chart illustrating an example of a selection process corresponding to at least one embodiment of the present invention.

FIG. 4 is a flow chart illustrating an example of an operation on a processing server side in a case where a processing server corresponding to at least one embodiment of the present invention executes a selection process.

FIG. 5 is a diagram illustrating an example of a list image of a plurality of articles displayed on a display unit of a user terminal corresponding to at least one embodiment of the present invention.

FIG. 6A is a plan view of a game pad which is an example of an operation unit of the user terminal corresponding to at least one embodiment of the present invention, and FIGS. 6B and 6C are side views of an operation stick of the game pad.

FIGS. 7A and 7B are diagrams illustrating an example of a list image of a plurality of articles displayed on the display unit of the user terminal corresponding to at least one embodiment of the present invention.

FIG. 8 is a functional block diagram illustrating a configuration of a user terminal corresponding to at least one embodiment of the present invention.

FIG. 9 is a flow chart illustrating an example of a selection process corresponding to at least one embodiment of the present invention.

FIG. 10 is a diagram illustrating an example of a list image of a plurality of articles displayed on a display unit of the user terminal corresponding to at least one embodiment of the present invention.

FIG. 11 is a functional block diagram illustrating a configuration of a user terminal corresponding to at least one embodiment of the present invention.

FIG. 12 is a flow chart illustrating an example of a selection process corresponding to at least one embodiment of the present invention.

FIGS. 13A and 13B are diagrams illustrating an example of a list image of a plurality of articles displayed on a display unit of the user terminal corresponding to at least one embodiment of the present invention.

FIG. 14 is a functional block diagram illustrating a configuration of a user terminal corresponding to at least one embodiment of the present invention.

FIG. 15 is a flow chart illustrating an example of a selection process corresponding to at least one embodiment of the present invention.

FIGS. 16A and 16B are diagrams illustrating an example of a list image of a plurality of articles displayed on a display unit of the user terminal corresponding to at least one embodiment of the present invention.

FIG. 17 is a functional block diagram illustrating a configuration of a user terminal corresponding to at least one embodiment of the present invention.

FIG. 18 is a flow chart illustrating an example of a selection process corresponding to at least one embodiment of the present invention.

FIG. 19 is a diagram illustrating an example of a multiplier table corresponding to at least one embodiment of the present invention.

FIG. 20 is a block diagram illustrating an example of a configuration of a video game processing system corresponding to at least one embodiment of the present invention.

FIG. 21 is a functional block diagram illustrating a configuration of a user terminal corresponding to at least one embodiment of the present invention.

FIGS. 22A to 22C are diagrams illustrating an example of a list image (command menu) of a plurality of articles displayed on a display unit of the user terminal corresponding to at least one embodiment of the present invention.

FIGS. 23A to 23C are diagrams illustrating an example of a list image (command menu) of a plurality of articles displayed on the display unit of the user terminal corresponding to at least one embodiment of the present invention.

FIG. 24 is a diagram illustrating an example of a command table corresponding to at least one embodiment of the present invention.

FIG. 25 is a diagram illustrating an example of a registration screen displayed on the display unit of the user terminal corresponding to at least one embodiment of the present invention.

FIG. 26 is a diagram illustrating an example of a region table corresponding to at least one embodiment of the present invention.

FIG. 27 is a flow chart illustrating an example of a registration process corresponding to at least one embodiment of the present invention.

FIG. 28 is a flow chart illustrating an example of an operation on a processing server side in a case where a game processing server corresponding to at least one embodiment of the present invention executes a registration process.

FIG. 29 is a flow chart illustrating an example of a selection process corresponding to at least one embodiment of the present invention.

FIG. 30 is a diagram illustrating an example of a list image (command menu) of a plurality of articles displayed on the display unit of the user terminal corresponding to at least one embodiment of the present invention.

FIG. 31 is a diagram illustrating an example of a list image (command menu) of a plurality of articles displayed on the display unit of the user terminal corresponding to at least one embodiment of the present invention.

FIG. 32 is a diagram illustrating an example of a list image (command menu) of a plurality of articles displayed on the display unit of the user terminal corresponding to at least one embodiment of the present invention.

### DESCRIPTION OF EMBODIMENTS

Hereinafter, examples of embodiments of the present invention will be described with reference to the drawings. Various constituent elements in the examples of the embodiments described below may be combined with each other as appropriate, unless contradiction or the like occurs therein. The content described in an example of a certain embodiment is not described in other embodiments in some cases. The content of an operation or a process which is not related to a feature portion of each embodiment is omitted in some cases. An order of various processes constituting various flows described below is arbitrary, unless contradiction or the like occurs in the process content.

### First Embodiment

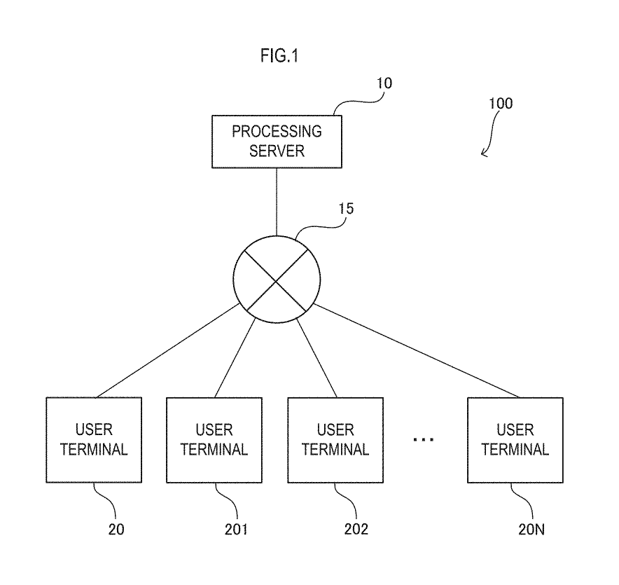

FIG. 1 is a block diagram illustrating an example of a configuration of an article selection processing system 100 according to an embodiment of the present invention. As illustrated in FIG. 1, the article selection processing system 100 includes a processing server 10, and user terminals 20 and 201 to 20N (where N is any integer) used by a user selecting at least one article from among a plurality of articles. The processing server 10 and the plurality of user terminals 20 and 201 to 20N are connected to a communication network 15 such as the Internet. Meanwhile, a configuration of the article selection processing system 100 is not limited thereto. For example, a configuration in which a plurality of users use a single user terminal or a configuration in which a plurality of processing servers are provided may be adopted. In addition, the article selection processing system may also be constituted by only user terminals not including a processing server.

For example, the article selection processing system 100 has various functions of receiving operation information of operation devices (operation unit) of the user terminals 20 (201 to 20N) and selecting one article from among a plurality of articles displayed on display devices (display units) of the user terminals 20 (201 to 20N) on the basis of the operation information. A process associated with the selected article is executed in the article selection processing system 100.

The processing server 10 is managed by a manager of the article selection processing system 100. The processing server 10 has various functions for providing information regarding articles selected by respective users to the user terminals 20 and 201 to 20N. For example, the processing server 10 receives the information regarding an article selected by each user from each user terminal, and provides information (execution result of another user, and the like) regarding an execution result of a process associated with the selected article to each user (the user terminals 20 and 201 to 20N). In this embodiment, the processing server 10 is constituted by an information processing device such as a WWW server in order to provide information regarding an execution result and includes a database storing various information. However, this configuration is a general configuration, and thus a description thereof will be omitted here.

Each of the plurality of user terminals 20 and 201 to 20N is managed by a user who selects an article. Each of the user terminals 20 and 201 to 20N is constituted by a communication terminal, such as a personal computer or a stationary game device, in which an article can be selected.

In addition, each of the user terminals 20 and 201 to 20N includes an operation device (operation unit), a storage unit such as a hard disk drive (HDD), a control unit which is constituted by a CPU or the like which generates images of a plurality of articles, a display device (display unit) that displays the images, and the like in order to execute the selection of articles, but a detailed description thereof will be omitted. In addition, the storage units of the user terminals 20 and 201 to 20N store software (program) for executing the selection of an article in the example according to an embodiment of the present invention.

The operation units of the user terminals 20 and 201 to 20N can be tilted in any tilting direction by using the operation units (a tilting operation) of the user terminals 20 and 201 to 20N, and the operation units are set to be in an erected state (neutral state) when the tilting operation is canceled. The user terminals 20 and 201 to 20N receive pieces of operation information including the amount of tilting and the tilting direction of the tilting operation from the operation units thereof. For example, the amount of tilting and the tilting direction are the amount of tilting and the tilting direction of the operation unit based on a neutral state. Meanwhile, the detection of the amount of tilting and the tilting direction of the operation unit is a general configuration using a sensor and the like, and thus a detailed description thereof will be omitted.

The user performs the tilting operation to thereby select one article from among the plurality of articles displayed on the display units of the user terminals 20 and 201 to 20N. A plurality of articles are displayed on the display units in a state where the plurality of articles are disposed along a predetermined direction with respect to a reference position of a screen coordinate system. For example, 30 articles are displayed on the display units. In the user terminals 20 and 201 to 20N in the example according to this embodiment, a selection process of selecting one article on the basis of the information regarding the amounts of tilting and the tilting directions included in the operation information of the operation units is performed. The selection process includes a direction determination process of determining an indicating direction in which one article is indicated from a reference position, and a correction process of correcting the determined indicating direction (fine adjustment). The direction determination process is executed in a case where the amount of tilting is less than a predetermined threshold value. In addition, the correction process is executed in a case where the amount of tilting is equal to or greater than the predetermined threshold value. That is, the direction determination process and the correction process are performed in a switching manner in accordance with the amount of tilting.

In the direction determination process, an indicating direction in which one article is indicated from a reference position is determined, on the basis of the tilting direction of the operation unit. In addition, in the correction process, the amount of correction is calculated on the basis of the amount of change in a tilting direction based on the tilting direction (reference tilting direction) at the time of determination of the indicating direction, and the indicating direction is corrected in accordance with the amount of correction. That is, in the correction process, the tilting direction is not directly set as an indicating direction, unlike in the direction determination process.

As described above, switching between the execution of the direction determination process and the execution of the correction process is performed on the basis of the amount of tilting, and thus the direction determination process is performed in a state where the amount of tilting at the time of the start of a tilting operation is small, thereby roughly determining an indicating direction. Thereafter, the correction process is performed in a state where the amount of tilting is increased, thereby performing fine adjustment in the indicating direction.

Therefore, a user may tilt the operation unit to such an extent that the vicinity of one article desired to be selected is indicated at the time of the start of the tilting operation, and then may perform fine adjustment (correction) of an indicating direction by changing the tilting direction so that one article desired to be selected is indicated. Meanwhile, a calculation expression for the amount of correction based on the amount of change can be arbitrarily set as long as the amount of correction can be calculated.

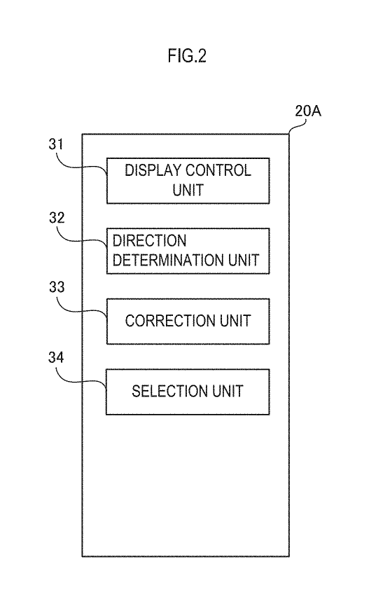

FIG. 2 is a functional block diagram illustrating a configuration of a user terminal 20A which is an example of a configuration of the user terminal 20. The user terminal 20A includes at least a display control unit 31, a direction determination unit 32, a correction unit 33, and a selection unit 34, for selecting one article from among a plurality of articles by the control unit executing the program stored in the storage unit. Meanwhile, the other user terminals 201 to 20N have the same configuration, and thus a description thereof will be omitted there.

As described above, the display control unit 31 displays the plurality of articles disposed along a predetermined direction with respect to a reference position of the screen coordinate system, on a display unit of the user terminal 20A. Meanwhile, information such as articles to be displayed, a reference position, and the arrangement positions of the articles may be included in, for example, data of the program. As described above, the direction determination unit 32 determines an indicating direction on the basis of a tilting direction in a case where the amount of tilting is less than the predetermined threshold value. For example, the direction determination unit 32 may make a neutral position of the operation unit and a reference position in a screen coordinate system conform each other, and may set a direction which is the same as the tilting direction of the operation unit to be an indicating direction.

As described above, in a case where the amount of tilting is equal to or greater than the predetermined threshold value, the correction unit 33 sets a tilting direction at the time of determination of the indicating direction determined in the direction determination process (direction determination unit 32) to be a reference direction (reference tilting direction), and determines the amount of correction on the basis of the amount of change in the tilting direction. The correction unit 33 corrects the indicating direction determined in the direction determination process, in accordance with the amount of correction. Meanwhile, it is preferable that the amount of correction is determined so that the indicating direction is easily corrected to an article in the vicinity which is indicated by the indicating direction determined in the direction determination process.

In a case where the amount of tilting is equal to or greater than the predetermined threshold value, the selection unit 34 selects an article indicated by the indicating direction. That is, an article indicated by the indicating direction corrected by the correction unit 33 is selected. For example, in case where the determination button included in the operation unit is operated by the user in a state where the amount of tilting of the operation unit is equal to or greater than the predetermined threshold value, the selection unit 34 select (fixedly set) the article indicated by the indicating direction.

Next, the operation of the article selection processing system 100 (system 100) according to this embodiment will be described.

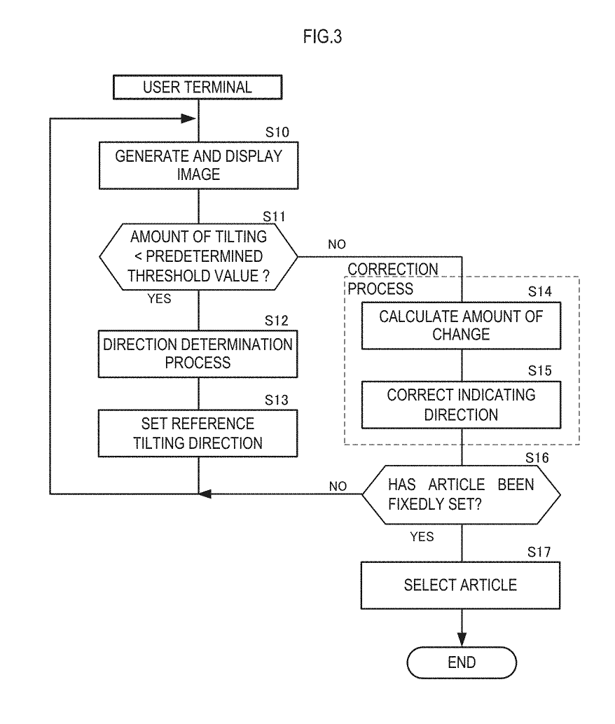

FIG. 3 is a flow chart illustrating an example of a selection process performed by the system 100. In the selection process in this example, a process of selecting one article from among a plurality of articles displayed on the display unit is performed. Hereinafter, a case where the user terminal 20A performs the selection process will be described as an example.

For example, the selection process in this example is performed in a case where an operation of the operation unit for displaying articles is performed. Meanwhile, in a case where the selection of an article is canceled, the process may be forcibly terminated.

In the selection process, the user terminal 20A generates images of the plurality of articles and displays the generated images on the display unit as described above (step S10). Next, the user terminal 20A determines whether or not the amount of tilting of the operation unit is less than the predetermined threshold value (step S11). In a case where it is determined that the amount of tilting is less than the predetermined threshold value (step S11: YES), the user terminal 20A performs a direction determination process of determining an indicating direction as described above (step S12). Next, the user terminal 20A sets (updates) a tilting direction at the time of the determination of the indicating direction as a reference tilting direction (step S13). Thereafter, the user terminal 20A returns to the processing of step S10.

On the other hand, in a case where it is determined in the processing of step S11 that the amount of tilting is not less than the predetermined threshold value, the user terminal 20A determines that the amount of tilting is equal to or greater than the predetermined threshold value, and performs a correction process of correcting the above-described indicating direction (steps S14 and S15). Specifically, the user terminal 20A firstly calculates the amount of change in the tilting direction with respect to the reference tilting direction (step S14). Next, the user terminal 20A calculates the amount of correction based on the amount of change to thereby correct the indicating direction (step S15).

Thereafter, the user terminal 20A determines whether or not an article indicated by the indicating direction has been selected (fixedly set) (step S16). The user terminal 20A determines that the article has been selected (fixedly set), for example, in a case where the determination button of the operation unit is operated. In a case where the article has been fixedly set (step S16: YES), the user terminal 20A selects the article indicated by the indicating direction (step S17) and terminates the selection process. On the other hand, in a case where the article has not been fixedly set (step S16: NO), the user terminal 20A returns to the processing of step S10 and continuously performs the direction determination process and the correction process in accordance with the amount of tilting.

As described above, as an aspect of the first embodiment, the user terminal 20A is configured to include the display control unit 31, the direction determination unit 32, the correction unit 33, and the selection unit 34, and thus an indicating direction is determined in accordance with the tilting direction of the operation unit and is then corrected. That is, fine adjustment of the indicating direction can be performed after the indicating direction is roughly determined on the basis of the tilting direction. Accordingly, even when one article is selected from among a large number of articles, one article desired to be selected is easily indicated. Therefore, it is possible to improve user operability.

Meanwhile, in the example according to the first embodiment described above, the user terminal 20A executes a program and selects one article from among a plurality of articles, but is not particularly limited thereto. Instead of the user terminal 20A, the processing server 10 may be configured to include the display control unit 31, the direction determination unit 32, the correction unit 33, and the selection unit 34.

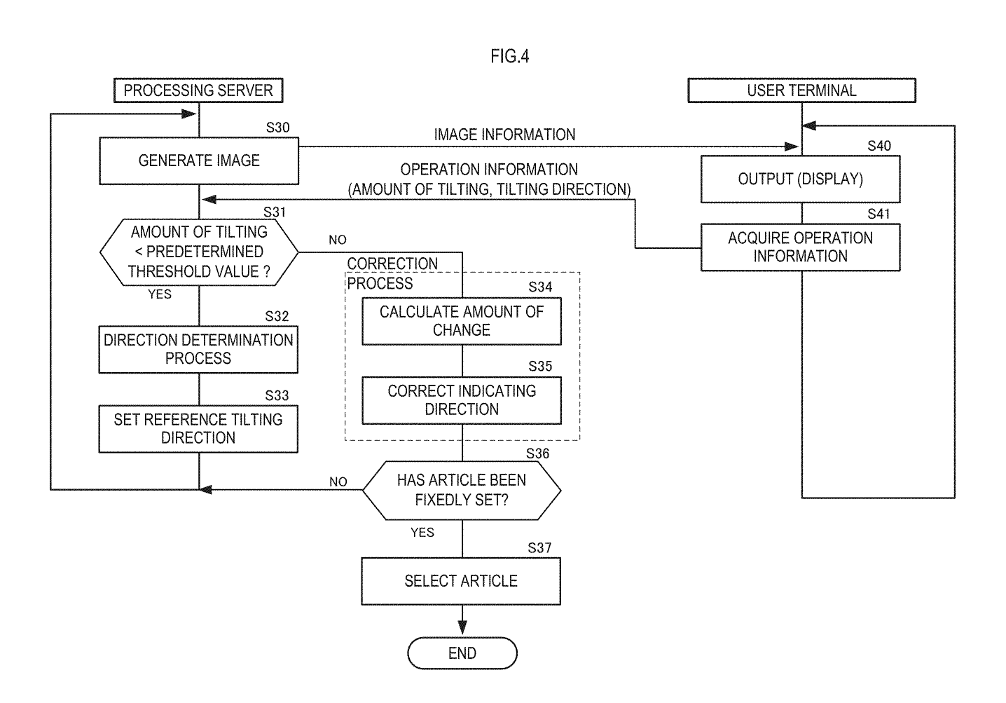

FIG. 4 is a flow chart illustrating an example of operations of the processing server 10 (server 10) and the user terminal 20 in a case where the processing server 10 performs the selection process illustrated in FIG. 3. In the selection process, the server 10 generates images of a plurality of articles (step S30). The server 10 transmits image information of the images to the user terminal 20. The user terminal 20 displays the images of the plurality of articles based on the received image information on the display unit (step S40). In addition, the user terminal 20 acquires operation information of the operation unit (step S41), and transmits the acquired operation information to the server 10. The operation information includes the amount of tilting and the tilting direction of the operation unit.

Next, the server 10 determines whether or not the received amount of tilting of the operation unit is less than a predetermined threshold value (step S31). In a case where it is determined that the amount of tilting is less than the predetermined threshold value (step S31: YES), the server 10 performs a direction determination process of determining an indicating direction (step S32). Next, the server sets (updates) a tilting direction at the time of determining the indicating direction as a reference tilting direction (step S33). Thereafter, the server returns to the processing of step S30.

On the other hand, in a case where it is determined in the processing of step S31 that the amount of tilting is not less than the predetermined threshold value, the server 10 determines that the amount of tilting is equal to or greater than the predetermined threshold value, and performs a correction process of correcting the indicating direction (steps S34 and S35).

Thereafter, the server 10 determines whether or not an article indicated by the indicating direction has been selected (fixedly set) (step S36). In a case where the article has been fixedly set (step S36: YES), the server 10 selects the article indicated by the indicating direction (step S37) and terminates the selection process. On the other hand, in a case where the article has not been fixedly set (step S36: NO), the server 10 returns to the processing of step S30 and continuously performs the direction determination process and the correction process in accordance with the amount of tilting.

Meanwhile, the article selection processing system 100 in the example according to the first embodiment described above is, for example, a video game processing system. For example, the video game processing system executes a video game in which each of a plurality of users (players) operates a player object in the same (common) three-dimensional game space (synchronized virtual space). The user may select an article (command) indicating a motion to be performed on the player object from among a plurality of articles displayed on the display unit. Examples of the motion include greeting, hand-waving, and the like. In this case, a processing server is a game processing server, and a user terminal is a game terminal.

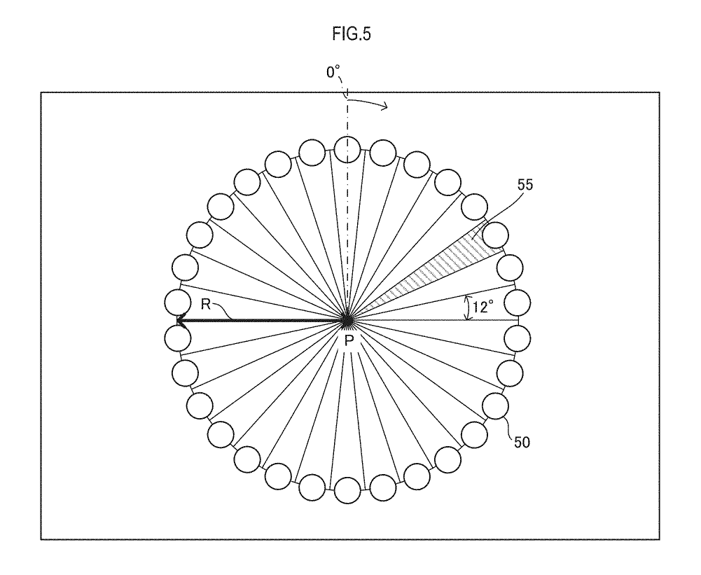

In addition, the plurality of articles in the example according to the first embodiment described above may be disposed, for example, in the form as illustrated in FIG. 5. FIG. 5 is a diagram illustrating an example of a list image of a plurality of articles 50 displayed on the display unit of the user terminal 20. The plurality of articles 50 are circular images, and are disposed along the circumferential direction (predetermined direction) of a circle having a radius R based on a reference position P in a screen coordinate system. That is, the plurality of articles 50 are disposed in a ring shape. FIG. 5 illustrates a state where 30 articles 50 are disposed at equal intervals. Meanwhile, the predetermined direction is not limited to the circumferential direction, and may be, for example, a linear direction.

In the above-described example, the article 50 indicated by an indicating direction is specified using a separate region 55. The separate regions 55 are fan-like regions obtained by equally dividing a circular region based on the reference position P in the circumferential direction. That is, the separate regions are regions obtained by dividing a range capable of being indicated by the indicating direction from the reference position P in the predetermined direction (circumferential direction). The range capable of being indicated means a range in a direction capable of being set to be an indicating direction. For example, a shaded region in FIG. 5 indicates one separate region 55. Each separate region 55 is associated with one article 50. The article 50 associated with the separate region 55 including an indicating direction is selected as an article indicated by the indicating direction. Meanwhile, the separate region 55 may not be set. In this case, for example, an article positioned on an indicating direction may be selected as an article indicated by the indicating direction on the basis of the indicating direction and arrangement coordinates of an image of the article in the screen coordinate system. Meanwhile, the separate regions 55 are illustrated in FIG. 5 for convenience of description, but are not actually displayed on the display unit.

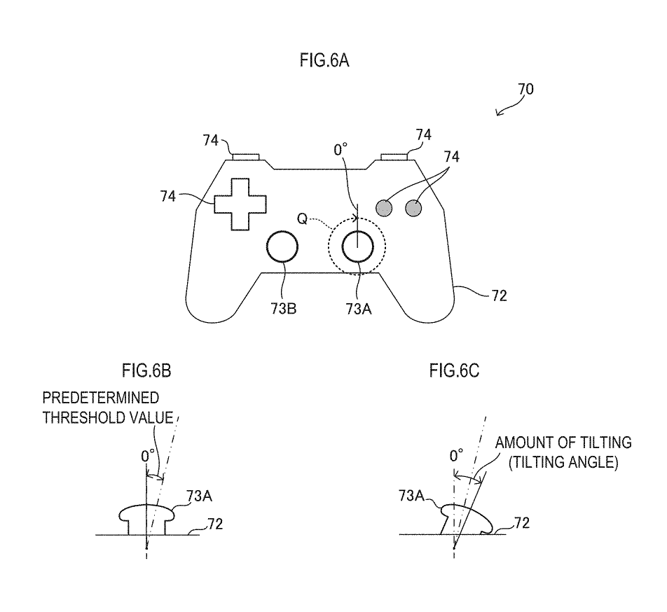

In addition, the operation unit in the example according to the first embodiment described above is, for example, a controller (game pad) 70 for a video game as illustrated in FIG. 6A. FIG. 6A is a plan view of the game pad 70 which is an example of the operation unit of the user terminal 20. FIGS. 6B and 6C are side views of an operation stick 73A of the game pad 70. The game pad 70 includes two operation sticks 73A and 73B and a plurality of buttons 74 in a main body 72.

The operation stick 73A can be tilted in any direction as illustrated in FIG. 6C. In addition, the operation stick 73A is set to be an erected state (neutral state) in a state where the tilting operation thereof is canceled as illustrated in FIG. 6B. In this case, in FIG. 6A, the tilting direction of the operation stick 73A upward the game pad 70 is set to 0 degree, and a clockwise round (arrow Q) is set to 360 degrees, whereby numerical information of an angle may be set to be information of the tilting direction of the operation stick 73A. That is, in a case where the tilting direction is 0 degree, it is indicated that the operation stick 73A is tilted upward the game pad 70 in FIG. 6A. Meanwhile, the operation stick 73B also has the same configuration.

For example, a case where one article 50 is selected from among the plurality of articles 50 illustrated in FIG. 5 by tilting the operation stick 73A of the game pad 70 will be described. In this case, the position of the operation stick 73A in a neutral state is made to conform to the reference position P. In addition, a direction upward from the reference position P is set to 0 degree, and a clockwise round is set to 360 degrees, whereby a direction from the reference position P is specified as numerical information of an angle.

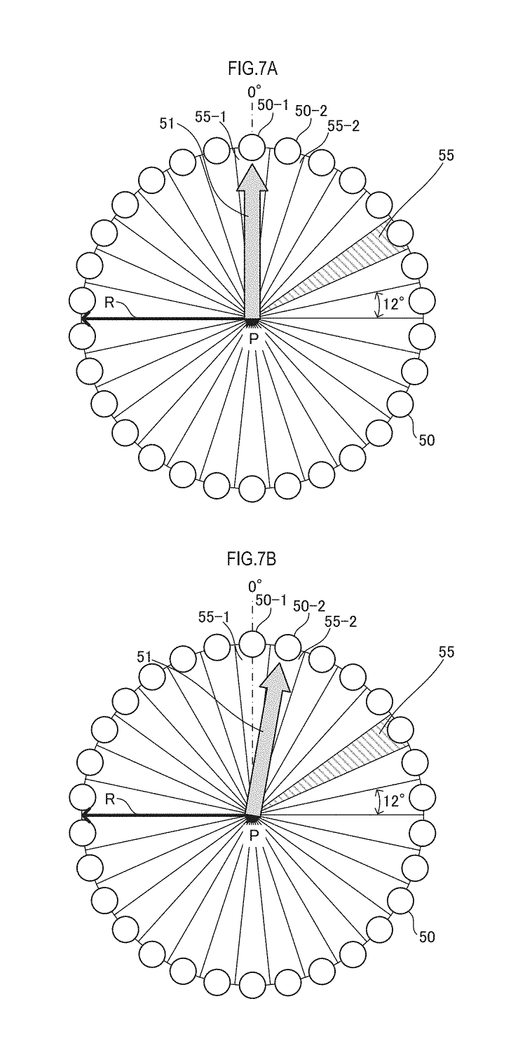

First, when a tilting operation of the operation stick 73A is started and the amount of tilting is less than the predetermined threshold value, the same direction as a tilting direction is determined to be an indicating direction. For example, in a case where the tilting direction is set to 0 degree, the indicating direction is also set to 0 degree, and thus a select beam 51 as illustrated in FIG. 7A is displayed on the display unit. The select beam 51 is an arrow image for specifying the indicating direction. Thereafter, in a case where the amount of tilting of the operation stick 73A is equal to or greater than the predetermined threshold value in the state illustrated in FIG. 7A, the correction of the select beam 51 (indicating direction) illustrated in FIG. 7A is performed. In this case, a reference tilting direction is set to 0 degree, and thus the amount of correction is determined on the basis of the amount of change in the tilting direction. For example, one third of the amount of change is set to be the amount of correction. In a case where the tilting direction is corrected from 0 degree to 30 degrees by the clockwise rotation of the operation stick 73A during a tilting operation, the amount of change with respect to the reference tilting direction of 0 degree is set to 30 degrees, and thus the amount of correction is set to 10 degrees. Therefore, the select beam 51 (indicating direction) is corrected by 10 degrees from the state illustrated in FIG. 7A, and is thus set to be in the state illustrated in FIG. 7B. That is, the indicating direction is included in a separate region 55-2, and is thus set to be in a state where an article 50-2 is indicated.

Meanwhile, the predetermined threshold value in the example according to the first embodiment described above can be arbitrarily set. For example, a maximum amount of tilting (maximum tilting angle) of the operation unit may be set to 100%, and 90% may be set to be the predetermined threshold value.

In addition, in the example according to the first embodiment described above, the indicating direction is corrected by the correction process, but is not particularly limited as long as a relative positional relationship between the indicating direction and the plurality of articles can be corrected. For example, correction to shift the arrangement positions of the plurality of articles may be performed without changing the indicating direction. Specifically, in a case of the plurality of articles 50 disposed in a ring shape as illustrated in FIG. 5, the arrangement positions of the plurality of articles are shifted (rotationally moved) clockwise or counterclockwise in accordance with the amount of correction.

For example, in a case where the amount of correction is 10 degrees in the state illustrated in FIG. 7A, the articles 50 may be rotationally moved clockwise by 10 degrees on the basis of the reference position P without changing the select beam 51 (indicating direction). In this case, the articles may be rotationally moved in a direction (counterclockwise) opposite to a clockwise direction. Meanwhile, both the correction of the indicating direction and the correction for shifting may be performed in accordance with the amount of correction.

### Second Embodiment

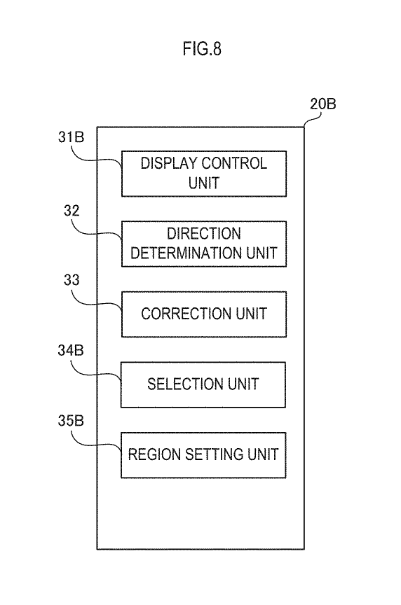

FIG. 8 is a block diagram illustrating a configuration of a user terminal 20B which is an example of the user terminal 20. In this example, the user terminal 20B includes at least a display control unit 31B, a direction determination unit 32, a correction unit 33, a selection unit 34B, and a region setting unit 35B.

The region setting unit 35B sets separate regions obtained by dividing a range capable of being indicated by an indicating direction from a reference position in a predetermined direction. The range capable of being indicated means a range in a direction capable of being set to be an indicating direction. In addition, the region setting unit 35B associates one of a plurality of articles with each of the separate regions. For example, the region setting unit 35B stores a region table in a storage unit of the user terminal 20B. The region table is a table in which a correspondence relationship between the separate region and the article is specified. The display control unit 31B displays the plurality of articles disposed along a predetermined direction with respect to a reference position of a screen coordinate system on a display unit of the user terminal 20B. In the example according to this embodiment, the associated article is disposed at a position corresponding to each of the separate regions.

In a case where the amount of tilting is less than a predetermined threshold value, the direction determination unit 32 determines an indicating direction on the basis of a tilting direction. In a case where the amount of tilting is equal to or greater than the predetermined threshold value, the correction unit 33 determines the amount of correction and corrects the indicating direction. In a case where the amount of tilting is equal to or greater than the predetermined threshold value, the selection unit 34B selects an article indicated by the indicating direction. In the example according to this embodiment, the selection unit 34B selects an article associated with a separate region including the indicating direction.

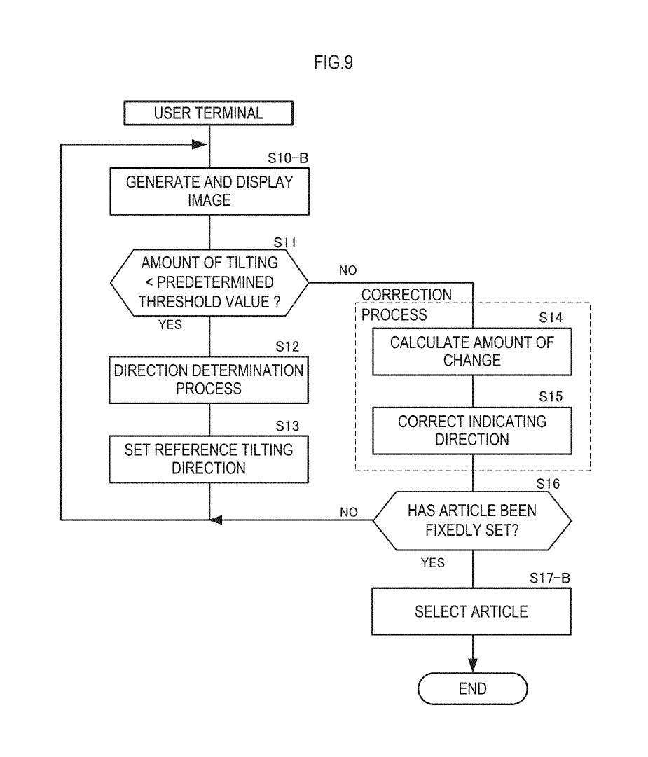

FIG. 9 is a flow chart illustrating an example of a selection process performed by the system 100. In the selection process in this example, a process of selecting one article from among a plurality of articles displayed on the display unit is performed. Hereinafter, a case where the user terminal 20B performs a selection process will be described as an example. Meanwhile, a description of a flow chart illustrating the operation of the processing server 10 will be omitted from the viewpoint of avoiding a repeated description.

For example, the selection process in this example is performed in a case where an operation of an operation unit for displaying articles is performed. Meanwhile, in a case where the selection of an article is canceled, the process may be forcibly terminated.

In the selection process, the user terminal 20B generates images of the plurality of articles disposed in accordance with the respective separate regions and displays the generated images on the display unit as described above (step S10-B). Next, the user terminal 20B determines whether or not the amount of tilting of the operation unit is less than the predetermined threshold value (step S11). In a case where it is determined that the amount of tilting is less than the predetermined threshold value (step S11: YES), the user terminal 20B performs a direction determination process of determining an indicating direction (step S12). Next, the user terminal 20B sets (updates) a tilting direction at the time of the determination of the indicating direction as a reference tilting direction (step S13). Thereafter, the user terminal 20B returns to the processing of step S10-B.

On the other hand, in a case where it is determined in the processing of step S11 that the amount of tilting is not less than the predetermined threshold value, the user terminal 20B performs a correction process of correcting the indicating direction (steps S14 and S15). Thereafter, the user terminal 20B determines whether or not an article corresponding to the indicating direction has been selected (fixedly set) (step S16). In a case where the article has been fixedly set (step S16: YES), the user terminal 20B selects an article indicated by the indicating direction (step S17-B) and terminates the selection process. In the example according to this embodiment, an article associated with a separate region including the indicating direction is selected as described above. On the other hand, in a case where the article has not been fixedly set (step S16: NO), the user terminal 20B returns to the processing of step S10-B and continuously performs the direction determination process and the correction process in accordance with the amount of tilting.

As described above, as an aspect of the second embodiment, the user terminal 20B is configured to include the display control unit 31B, the direction determination unit 32, the correction unit 33, the selection unit 34B, and the region setting unit 35B. Accordingly, an indicating direction is determined in accordance with the tilting direction of the operation unit, and is then corrected. That is, fine adjustment of the indicating direction can be performed after the indicating direction is roughly determined on the basis of the tilting direction. Accordingly, even when one article is selected from among a large number of articles, one article desired to be selected is easily indicated. Therefore, it is possible to improve user operability.

Meanwhile, the separate regions in the example according to the second embodiment described above are, for example, the separate regions 55 illustrated in FIG. 5 according to the first embodiment. The separate regions 55 illustrated in FIG. 5 are fan-like regions obtained by equally dividing a circular region having a radius R based on the reference position P in the screen coordinate system in the circumferential direction. The number of separate regions 55 is 30 which is the same number of articles 50, and a central angle of one separate region 55 is 12 degrees. Therefore, when the indicating direction is in a range (central angle of 12 degrees) which is included in the separate region 55, it is possible to select the article 50 that a user desires to select even when the indicating direction does not completely conform to the arrangement position of the article 50 that the user desires to select. Meanwhile, the separate regions 55 may not be configured as equal regions obtained by division.

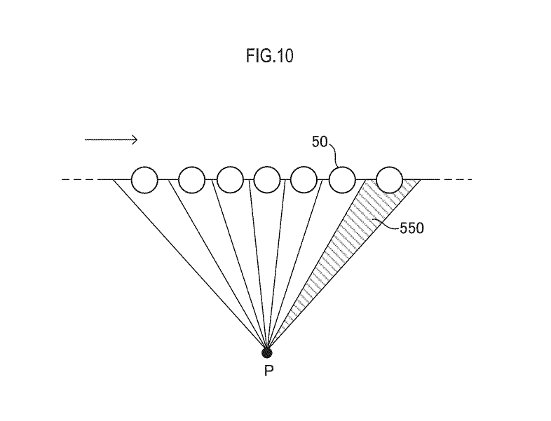

In addition, for example, in a case where the plurality of articles 50 are disposed in a linear direction (predetermined direction) as illustrated in FIG. 10, separate regions 550 obtained by equally performing division in the linear direction may be used. A shaded region illustrated in FIG. 10 indicates one separate region 550.

In addition, a boundary between the separate regions in the example according to the second embodiment described above may be set to be included in any of two adjacent separate regions.

Further, the separate region in the example according to the second embodiment described above is associated with one article, but a separate region which is not associated with one article may be included.

In addition, in the example according to the second embodiment described above, the indicating direction is corrected by the correction process, but is not particularly limited as long as a relative positional relationship between the indicating direction and the plurality of articles can be corrected. For example, correction to shift the arrangement positions of the plurality of articles may be performed without changing the indicating direction. In addition, both the correction of the indicating direction and the correction for shifting may be performed in accordance with the amount of correction.

### Third Embodiment

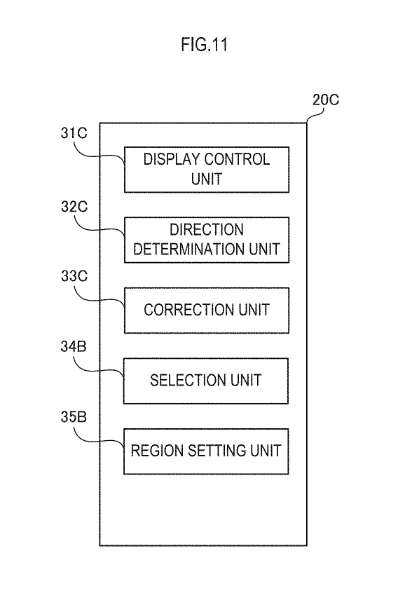

FIG. 11 is a block diagram illustrating a configuration of a user terminal 20C which is an example of the user terminal 20. In this example, the user terminal 20C includes at least a display control unit 31C, a direction determination unit 32C, a correction unit 33C, a selection unit 34B, and a region setting unit 35B.

The region setting unit 35B sets separate regions obtained by dividing a range capable of being indicated by a tilting operation from a reference position in a predetermined direction. The display control unit 31C displays a plurality of articles disposed along a predetermined direction with respect to a reference position of a screen coordinate system on a display unit of the user terminal 20C. In the example according to this embodiment, the associated article is disposed at a position corresponding to each of the separate regions. In more detail, the article is displayed on the display unit in a state where the article associated with the separate region is disposed on a central direction which is a direction passing through the center of the separate region from the reference position.

In a case where the amount of tilting is less than a predetermined threshold value, the direction determination unit 32C determines an indicating direction on the basis of a tilting direction. In the example according to this embodiment, any one of central directions of the respective separate regions is determined to be an indicating direction on the basis of a tilting direction of an operation unit. For example, the direction determination unit 32C specifies in which separate region a direction from the reference position based on the tilting direction is included, and determines the central direction of the separate region including the direction to be an indicating direction.

In a case where the amount of tilting is equal to or greater than the predetermined threshold value, the correction unit 33C determines the amount of correction and corrects the indicating direction. In addition, in the example according to this embodiment, the correction unit 33C corrects the indicating direction determined by the direction determination unit 32C (direction determination process) to a central direction of any one of the separate regions in accordance with the amount of correction. For example, the correction unit 33C specifies in which separate region a direction in which the indicating direction is corrected in accordance with the amount of correction is included, and sets the central direction of the separate region including the direction to be an indicating direction. In a case where the amount of tilting is equal to or greater than the predetermined threshold value, the selection unit 34B selects an article indicated by the indicating direction. In the example according to this embodiment, the selection unit 34B selects an article associated with the separate region including the indicating direction.

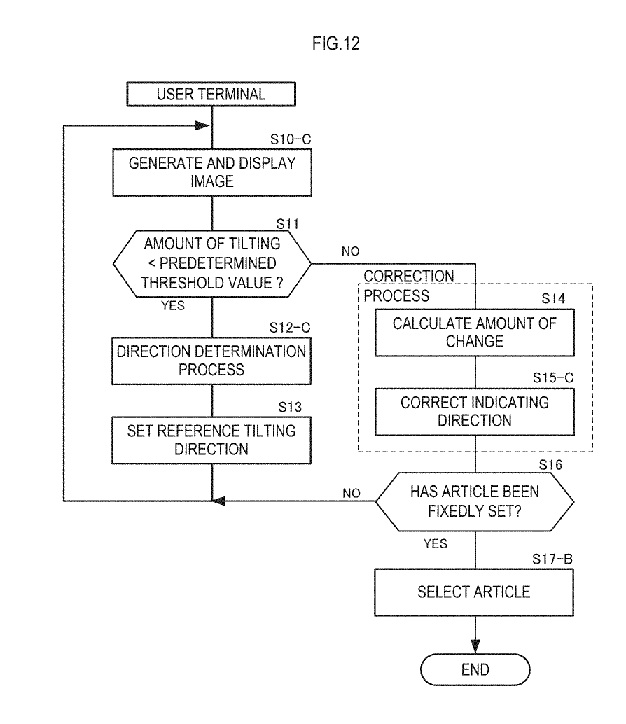

FIG. 12 is a flow chart illustrating an example of a selection process performed by the system 100. In the selection process according to this example, a process of selecting one article from among a plurality of articles displayed on the display unit is performed. Hereinafter, a case where the user terminal 20C performs a selection process will be described as an example. Meanwhile, a description of a flow chart illustrating the operation of the processing server 10 will be omitted from the viewpoint of avoiding a repeated description.

For example, the selection process in this example is performed in a case where an operation of the operation unit for displaying articles is performed. Meanwhile, in a case where the selection of an article is canceled, the process may be forcibly terminated.

In the selection process, the user terminal 20C generates images of the plurality of articles disposed on the central directions of the respective separate regions and displays the generated images on the display unit as described above (step S10-C). Next, the user terminal 20C determines whether or not the amount of tilting of the operation unit is less than the predetermined threshold value (step S11). In a case where it is determined that the amount of tilting is less than the predetermined threshold value (step S11: YES), the user terminal 20C performs a direction determination process of determining an indicating direction (step S12-C). In the direction determination process in the example according to this embodiment, any one of the central directions of the respective separate regions is determined to be an indicating direction on the basis of the tilting direction of the operation unit as described above. Next, the user terminal 20C sets (updates) a tilting direction at the time of the determination of the indicating direction as a reference tilting direction (step S13). Thereafter, the user terminal 20C returns to the processing of step S10-C.

On the other hand, in a case where it is determined in the processing of step S11 that the amount of tilting is not less than the predetermined threshold value, the user terminal 20C performs a correction process of correcting the indicating direction (steps S14 and S15-C). In the processing of step S15-C, it is specified in which separate region a direction obtained by correcting the indicating direction determined in the direction determination process in accordance with the amount of correction is included as described above, and the central direction of the separate region including the direction is set to be an indicating direction.

Thereafter, the user terminal 20C determines whether or not an article corresponding to the indicating direction has been selected (fixedly set) (step S16). In a case where the article has been fixedly set (step S16: YES), the user terminal 20C selects an article indicated by the indicating direction (step S17-B) and terminates the selection process. On the other hand, in a case where the article has not been fixedly set (step S16: NO), the user terminal 20C returns to the processing of step S10-C and continuously performs the direction determination process and the correction process in accordance with the amount of tilting.

As described above, as an aspect of the third embodiment, the user terminal 20C is configured to include the display control unit 31C, the direction determination unit 32C, the correction unit 33C, the selection unit 34B, and the region setting unit 35B. Accordingly, an indicating direction is determined in accordance with the tilting direction of the operation unit, and is then corrected. That is, fine adjustment of the indicating direction can be performed after the indicating direction is roughly determined on the basis of the tilting direction. Accordingly, even when one article is selected from among a large number of articles, one article desired to be selected is easily indicated. Therefore, it is possible to improve user operability.

In addition, the indicating direction is set to be the central direction of the separate region, and thus a user indicates an article more easily. In addition, since the article is also disposed on the central direction of the separate region, there is no positional deviation between the indicating direction and the article indicated in a case where the indicating direction is displayed on the display unit, and thus the user easily identifies the article.

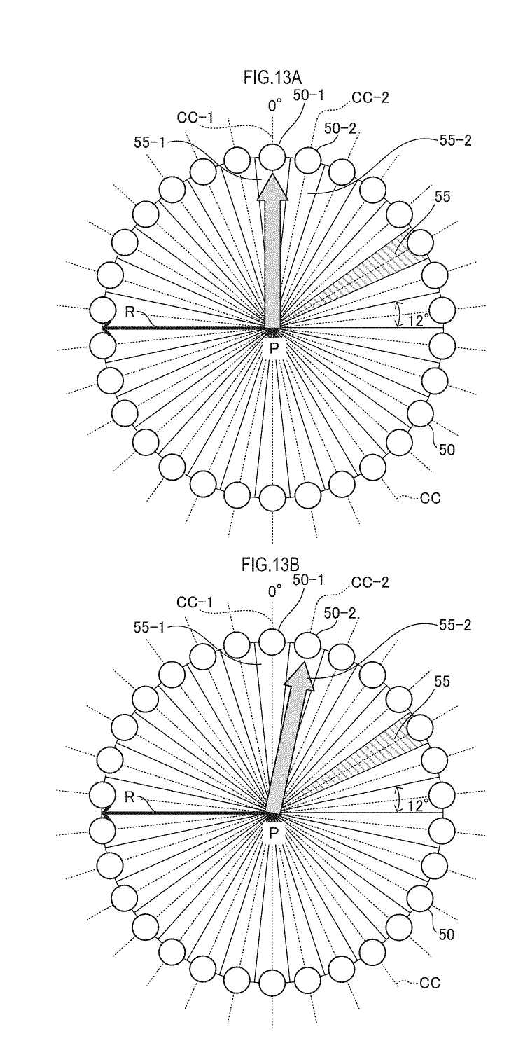

Meanwhile, the separate regions in the example according to the third embodiment described above are the separate regions 55 which are the same as those in FIG. 5 described in the first embodiment as illustrated in FIGS. 13A and 13B. The separate regions 55 illustrated in FIGS. 13A and 13B are fan-like regions obtained by equally dividing a circular region having a radius R based on a reference position P in the screen coordinate system in the circumferential direction. A shaded region illustrated in FIGS. 13A and 13B indicates one separate region 55. Each article 50 is disposed on a central direction CC which is a direction passing through the center of the separate region 55.

For example, a description will be given of a case where one article 50 is selected from among the plurality of articles 50 illustrated in FIGS. 13A and 13B by tilting the operation stick 73A of the game pad 70 illustrated in FIG. 6A according to the first embodiment. In this case, the position of the operation stick 73A in a neutral state is made to conform to the reference position P. In addition, a direction upward from the reference position P is set to 0 degree, and a clockwise round is set to 360 degrees, whereby a direction from the reference position P is specified as numerical information of an angle.

In a case where a tilting operation of the operation stick 73A is started (the amount of tilting is less than the predetermined threshold value) and a tilting direction is, for example, 5 degrees, a direction from the reference position based on the tilting direction is included in a separate region 55-1, and thus an indicating direction is set to a central direction CC-1 (0 degree) of the separate region 55-1. Therefore, a select beam 51 as illustrated in FIG. 13A is displayed on the display unit. Thereafter, in a case where the amount of tilting of the operation stick 73A is equal to or greater than the predetermined threshold value in the state illustrated in FIG. 13A, the correction of the select beam 51 (indicating direction) illustrated in FIG. 13A is performed. In this case, a reference tilting direction is set to 5 degrees, and the amount of correction is determined on the basis of the amount of change in the tilting direction. For example, one third of the amount of change is set to be the amount of correction. In a case where the tilting direction is corrected from 0 degree to 30 degrees by the clockwise rotation of the operation stick 73A during a tilting operation, the amount of change with respect to the reference tilting direction of 5 degrees is set to 25 degrees, and thus the amount of correction is set to approximately 8 degrees.

The select beam 51 (indicating direction) is set to a direction in which rotation is performed clockwise by approximately 8 degrees from the state illustrated in FIG. 13A, and is thus included in a separate region 55-2. Therefore, the select beam 51 (indicating direction) is corrected, and is thus set to be a central direction CC-2 of the separate region 55-2 illustrated in FIG. 13B. That is, the indicating direction is included in the separate region 55-2, and is thus set to be in a state where the article 50-2 is indicated. Meanwhile, the separate regions 55 may not be configured as equal regions obtained by division.

The center of the separate region in the example according to the third embodiment described above is a position at which an angle formed by two sides extending from the reference position in one separate region is divided into two equal parts. For example, in the fan-like separate regions 55 in FIGS. 13A and 13B, a position at which a fan-like central angle is divided into two equal parts is the center of the separate region 55.

In addition, the configuration in the example according to the third embodiment described above can also be applied to a configuration of the separate regions 550 obtained by division in the linear direction as illustrated in FIG. 10 described in the second embodiment. In this case, the center of the separate region 550 is also a position at which an angle formed by two sides extending from a reference position P in the separate region 550 is divided into two equal parts.

Further, a boundary between the separate regions in the example according to the third embodiment described above may be set to be included in any of two adjacent separate regions.

In addition, the separate region in the example according to the third embodiment described above is associated with one article, but a separate region which is not associated with one article may be included.

### Fourth Embodiment

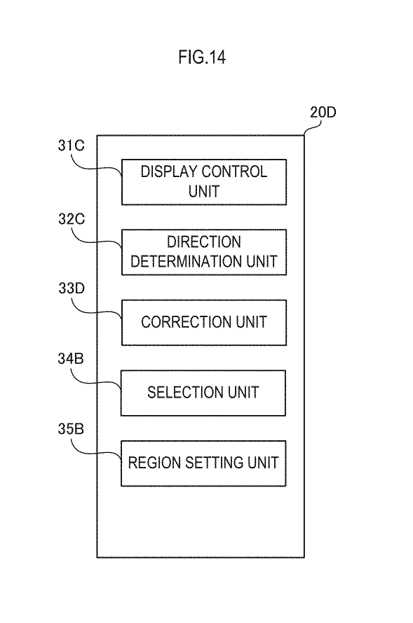

FIG. 14 is a block diagram illustrating a configuration of a user terminal 20D which is an example of the user terminal 20. In this example, the user terminal 20D includes at least a display control unit 31C, a direction determination unit 32C, a correction unit 33D, a selection unit 34B, and a region setting unit 35B.

The region setting unit 35B sets separate regions obtained by dividing a range capable of being indicated from a reference position in a predetermined direction by a tilting operation. In addition, the region setting unit 35B associates one of a plurality of articles with each of the separate regions. For example, the region setting unit 35B stores a region table in a storage unit of the user terminal 20D. The region table is a table in which a correspondence relationship between the separate region and the article is specified.

The display control unit 31C displays a plurality of articles disposed along a predetermined direction with respect to a reference position of a screen coordinate system on a display unit of the user terminal 20D. In the example according to this embodiment, the associated article is disposed at a position corresponding to each of the separate regions. In more detail, similarly to the example according to the third embodiment, the article is displayed on the display unit in a state where the article associated with the separate region is disposed on a central direction which is a direction passing through the center of the separate region from the reference position.

In a case where the amount of tilting is less than a predetermined threshold value, the direction determination unit 32C determines an indicating direction on the basis of a tilting direction. In the example according to this embodiment, similarly to the example according to the third embodiment, any one of central directions of the respective separate regions is determined to be an indicating direction on the basis of a tilting direction of an operation unit.

In a case where the amount of tilting is equal to or greater than the predetermined threshold value, the correction unit 33D determines the amount of correction and performs correction to shift the arrangement positions of the plurality of articles. In more detail, the correction unit 33D performs correction to shift the arrangement positions of the plurality of articles on a central direction of any one of the separate regions along a predetermined direction. For example, the correction unit 33D specifies in which separate region a position at which the arrangement positions of the plurality of articles are shifted is included in accordance with the amount of correction, and disposes the articles on the central direction of the separate region including the position. Therefore, in the example according to this embodiment, the correction of the indicating direction determined by the direction determination unit 32C is not performed. In a case where the amount of tilting is equal to or greater than the predetermined threshold value, the selection unit 34B selects an article indicated by the indicating direction. In the example according to this embodiment, the selection unit 34B selects an article associated with a separate region including the indicating direction.

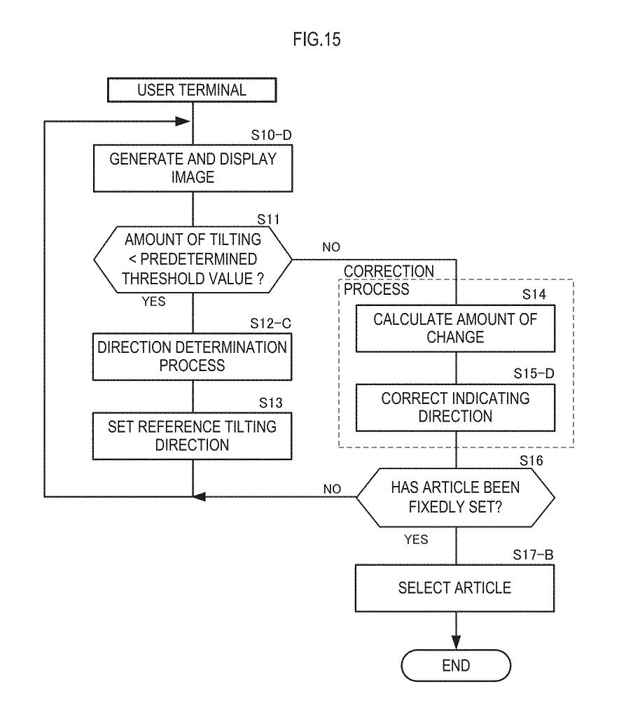

FIG. 15 is a flow chart illustrating an example of a selection process performed by the system 100. In the selection process in this example, a process of selecting one article from among a plurality of articles displayed on the display unit is performed. Hereinafter, a case where the user terminal 20D performs a selection process will be described as an example. Meanwhile, a description of a flow chart illustrating the operation of the processing server 10 will be omitted from the viewpoint of avoiding a repeated description.

For example, the selection process in this example is performed in a case where an operation of an operation unit for displaying articles is performed. Meanwhile, in a case where the selection of an article is canceled, the process may be forcibly terminated.

In the selection process, the user terminal 20D generates images of the plurality of articles disposed on the central directions of the respective separate regions and displays the generated images on the display unit as described above (step S10-D). Next, the user terminal 20D determines whether or not the amount of tilting of the operation unit is less than the predetermined threshold value (step S11). In a case where it is determined that the amount of tilting is less than the predetermined threshold value (step S11: YES), the user terminal 20D performs a direction determination process of determining an indicating direction (step S12-C). Similarly to the third embodiment, in the direction determination process, any one of the central directions of the respective separate regions is determined to be an indicating direction on the basis of the tilting direction of the operation unit. Next, the user terminal 20D sets (updates) a tilting direction at the time of the determination of the indicating direction as a reference tilting direction (step S13). Thereafter, the user terminal 20D returns to the processing of step S10-D.

On the other hand, in a case where it is determined in the processing of step S11 that the amount of tilting is not less than the predetermined threshold value, the user terminal 20D performs a correction process of correcting the indicating direction (steps S14 and S15-D). In the processing of step S15-D, as described above, it is specified in which separate region a position at which the arrangement position of each of the plurality of articles is shifted is included in accordance with the amount of correction, and the articles are disposed on the central direction of the separate region including the position. In addition, in the processing of step S15-D, association between each article and the separate region is updated in accordance with a correction result. This is because a correspondence relationship between the article and the separate region is also shifted by the amount of shift of the arrangement position. For example, the above-described region table may be updated.

Thereafter, the user terminal 20D determines whether or not an article corresponding to the indicating direction has been selected (fixedly set) (step S16). In a case where the article has been fixedly set (step S16: YES), the user terminal 20D selects the article indicated by the indicating direction (step S17-B) and terminates the selection process. On the other hand, in a case where the article has not been fixedly set (step S16: NO), the user terminal 20D returns to the processing of step S10-D and continuously performs the direction determination process and the correction process in accordance with the amount of tilting.

As described above, as an aspect of the fourth embodiment, the user terminal 20D is configured to include the display control unit 31C, the direction determination unit 32C, the correction unit 33D, the selection unit 34B, and the region setting unit 35B, and thus an indicating direction is determined in accordance with the tilting direction of the operation unit and is then corrected. That is, fine adjustment of the indicating direction can be performed after the indicating direction is roughly determined on the basis of the tilting direction. Accordingly, even when one article is selected from among a large number of articles, one article desired to be selected is easily indicated. Therefore, it is possible to improve user operability.

In addition, the indicating direction is set to be the central direction of the separate region, and thus a user indicates an article more easily. In addition, since the article is also disposed on the central direction of the separate region, there is no positional deviation between the indicating direction and the article indicated in a case where the indicating direction is displayed on the display unit, and thus the user easily identifies the article.

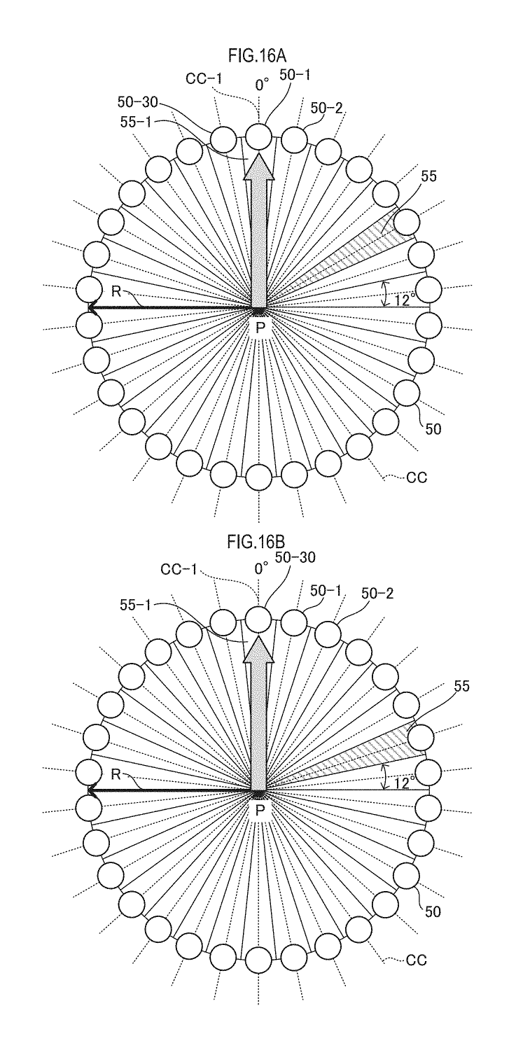

Meanwhile, the separate regions in the example according to the fourth embodiment described above are the separate regions 55 which are the same as those in FIG. 5 described in the first embodiment as illustrated in FIGS. 16A and 16B. The separate regions 55 illustrated in FIGS. 16A and 16B are fan-like regions obtained by equally dividing a circular region having a radius R based on a reference position P in the screen coordinate system in the circumferential direction. Shaded regions illustrated in FIGS. 16A and 16B indicate one separate region 55. Each article 50 is disposed on a central direction CC which is a direction passing through the center of the separate region 55.

For example, a description will be given of a case where one article 50 is selected from among the plurality of articles 50 illustrated in FIG. 16A by tilting the operation stick 73A of the game pad 70 illustrated in FIG. 6A according to the first embodiment. In this case, the position of the operation stick 73A in a neutral state is made to conform to the reference position P. In addition, a direction upward from the reference position P is set to 0 degree, and a clockwise round is set to 360 degrees, whereby a direction from the reference position P is specified as numerical information of an angle.

In a case where a tilting operation of the operation stick 73A is started (the amount of tilting is less than the predetermined threshold value) and a tilting direction is, for example, 5 degrees, a direction from the reference position based on the tilting direction is included in a separate region 55-1, and thus an indicating direction is set to a central direction CC-1 (0 degree) of the separate region 55-1. Therefore, a select beam 51 as illustrated in FIG. 16A is displayed on the display unit. Thereafter, in a case where the amount of tilting of the operation stick 73A is equal to or greater than the predetermined threshold value in the state illustrated in FIG. 16A, correction to shift the arrangement positions of the plurality of articles 50 is performed. In this case, a reference tilting direction is set to 5 degrees, and the amount of correction is determined on the basis of the amount of change in the tilting direction. For example, one third of the amount of change is set to be the amount of correction. In a case where the tilting direction is corrected to 30 degrees by the clockwise rotation of the operation stick 73A during a tilting operation, the amount of change with respect to the reference tilting direction of 5 degrees is set to 25 degrees, and thus the amount of correction is set to approximately 8 degrees.

The plurality of articles 50 are rotationally moved clockwise by approximately 8 degrees from the state illustrated in FIG. 16A. Therefore, as illustrated in FIG. 16B, for example, a state is set where an article 50-30 is displayed on the central direction CC-1 of the separate region 55-1. That is, a state is set where no change is made to the select beam 51 (indicating direction), but the article 50 to be indicated is changed from an article 50-1 to the article 50-30. In addition, the article 50-30 is associated with the separate region 55-1. In addition, the article 50 associated in accordance with rotational movement is also changed (updated) with respect to the other separate regions 55. Meanwhile, the separate regions 55 may not be configured as equal regions obtained by division. In addition, a direction of the rotational movement of the plurality of articles 50 may be opposite to a counterclockwise direction.

In addition, in the configuration in the example according to the fourth embodiment described above, correction in the indicating direction in the example according to the third embodiment is not performed in the correction process, but may be performed in combination.

Further, the configuration in the example according to the fourth embodiment described above can also be applied to a configuration of the separate regions 550 obtained by division in the linear direction as illustrated in FIG. 10 described in the second embodiment.

In addition, a boundary between the separate regions in the example according to the fourth embodiment described above may be set to be included in any of two adjacent separate regions.

Further, the separate region in the example according to the fourth embodiment described above is associated with one article, but a separate region which is not associated with one article may be included.

### Fifth Embodiment

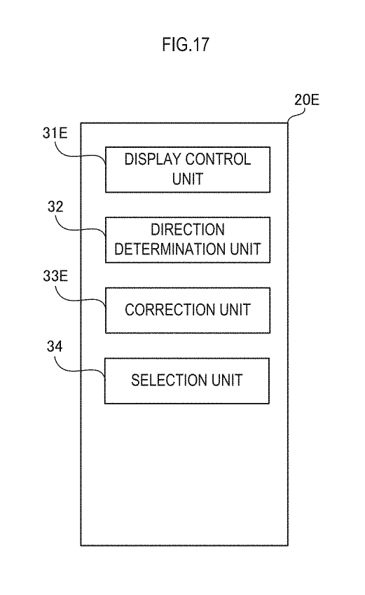

FIG. 17 is a block diagram illustrating a configuration of a user terminal 20E which is an example of the user terminal 20. In this example, the user terminal 20E includes at least a display control unit 31E, a direction determination unit 32, a correction unit 33E, and a selection unit 34.

The display control unit 31E displays a plurality of articles disposed along a predetermined direction with respect to a reference position of a screen coordinate system on a display unit of the user terminal 20E. In the example according to this embodiment, the plurality of articles are disposed at equal intervals based on the number of articles. That is, as the number of articles increases, a distance between the articles decreases. For example, a quotient obtained by setting the length of a region in which the plurality of articles are disposed in the predetermined direction to be a dividend and setting the number of articles to be a divisor is set to be an interval. Meanwhile, the number of articles is the number of plurality of articles displayed on the display unit. For example, the number of articles may be specified from information of articles to be displayed which are included in data of a program.

In a case where the amount of tilting is less than a predetermined threshold value, the direction determination unit 32 determines an indicating direction on the basis of a tilting direction. In a case where the amount of tilting is equal to or greater than the predetermined threshold value, the correction unit 33E determines the amount of correction and corrects the indicating direction. In the example according to this embodiment, the correction unit 33E determines the amount of correction on the basis of the amount of change and the number of plurality of articles. For example, even with the same amount of change, it is preferable to decrease the amount of correction to be calculated as the number of articles increases. This is because an interval between the articles decreases as the number of articles increases, which results in a reduction in the amount of correction of the indicating direction, thereby making it easier to perform more detailed correction. For example, in a case where the amount of correction is calculated by setting the amount of change to be a multiplicand, a numerical value used as a multiplier may be changed in accordance with the number of articles. A calculation expression for the amount of correction based on the amount of change and the number of articles can be arbitrarily set as long as the amount of correction can be calculated.

In a case where the amount of tilting is equal to or greater than the predetermined threshold value, the selection unit 34 selects an article indicated by the indicating direction.

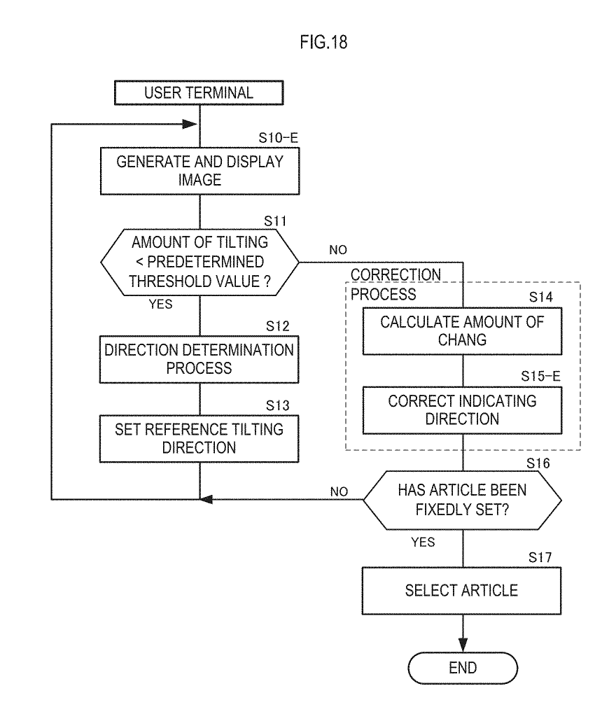

FIG. 18 is a flow chart illustrating an example of a selection process performed by the system 100. In the selection process in this example, a process of selecting one article from among a plurality of articles displayed on the display unit is performed. Hereinafter, a case where the user terminal 20E performs a selection process will be described as an example. Meanwhile, a description of a flow chart illustrating the operation of the processing server 10 will be omitted from the viewpoint of avoiding a repeated description.

For example, the selection process in this example is performed in a case where an operation of an operation unit for displaying articles is performed. Meanwhile, in a case where the selection of an article is canceled, the process may be forcibly terminated.

In the selection process, the user terminal 20E generates images of the plurality of articles disposed at equal intervals based on the number of articles and displays the generated images on the display unit as described above (step S10-E). Next, the user terminal 20E determines whether or not the amount of tilting of the operation unit is less than the predetermined threshold value (step S11). In a case where it is determined that the amount of tilting is less than the predetermined threshold value (step S11: YES), the user terminal 20E performs a direction determination process of determining an indicating direction (step S12). Next, the user terminal 20E sets (updates) a tilting direction at the time of the determination of the indicating direction as a reference tilting direction (step S13). Thereafter, the user terminal 20E returns to the processing of step S10-E.

On the other hand, in a case where it is determined in the processing of step S11 that the amount of tilting is not less than the predetermined threshold value, the user terminal 20E performs a correction process of correcting the indicating direction (steps S14 and S15-E). In the example according to this embodiment, in the processing of step S15-E, the user terminal 20E calculates the amount of correction based on the amount of change and the number of articles to thereby correct the indicating direction.

Thereafter, the user terminal 20E determines whether or not an article corresponding to the indicating direction has been selected (fixedly set) (step S16). In a case where the article has been fixedly set (step S16: YES), the user terminal 20E selects an article indicated by the indicating direction (step S17) and terminates the selection process. On the other hand, in a case where the article has not been fixedly set (step S16: NO), the user terminal 20E returns to the processing of step S10-E and continuously performs the direction determination process and the correction process in accordance with the amount of tilting.

As described above, as an aspect of the fifth embodiment, the user terminal 20E is configured to include the display control unit 31E, the direction determination unit 32, the correction unit 33E, and the selection unit 34. Accordingly, an indicating direction is determined in accordance with the tilting direction of the operation unit, and is then corrected. That is, fine adjustment of the indicating direction can be performed after the indicating direction is roughly determined on the basis of the tilting direction. Accordingly, even when one article is selected from among a large number of articles, one article desired to be selected is easily indicated. Therefore, it is possible to improve user operability.

In addition, the plurality of articles are displayed in a state where the articles are disposed at equal intervals, in accordance with the number of articles. In addition, the amount of correction is also determined in accordance with the number of articles, in addition to the amount of change. Therefore, even when a user can arbitrarily set (change) the number of articles to be displayed, the visibility of the plurality of articles is maintained, and it is possible to maintain user operability.

Meanwhile, the plurality of articles in the example according to the fifth embodiment described above may be disposed, for example, in the form as illustrated in FIG. 5 described in the first embodiment. In FIG. 5, the plurality of articles 50 are disposed at equal intervals along the circumferential direction of the circle having the radius R based on the reference position P in the screen coordinate system. In this case, a quotient obtained by setting the circumference of the circle having the radius R to be a dividend and setting the number of articles to be a divisor is set to be an interval between the articles. In addition, the same number of separate regions 55 as the number of articles are also in a state of being equally separated in the circumferential direction. Meanwhile, the present invention is not limited to the circumferential direction, and a linear direction may be set to be a predetermined direction. In addition, the separate regions 55 may not be set.

A description will be given of an example of the amount of correction in a case where one article 50 is selected from among the plurality of articles 50 illustrated in FIG. 5 by tilting the operation stick 73A of the game pad 70 illustrated in FIG. 6A described in the first embodiment. The position of the operation stick 73A in a neutral state is made to conform to the reference position P. In addition, a direction upward from the reference position P is set to 0 degree, and a clockwise round is set to 360 degrees, whereby a direction from the reference position P is specified as numerical information of an angle. In addition, since the tilting direction is numerical information of an angle, the amount of change in the tilting direction also serves as numerical information of the amount of change in the angle. The amount of correction is determined (calculated) by, for example, Expression (1).

Amount of Correction=Amount of Change×multiplier T (1)

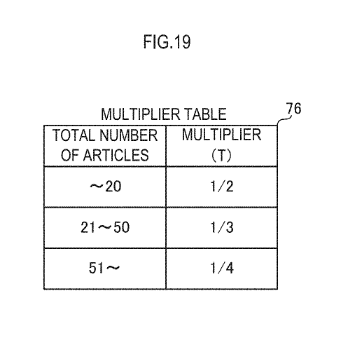

For example, the multiplier T is set in accordance with the number of articles as illustrated in FIG. 19. FIG. 19 illustrates an example of a multiplier table 76. In the multiplier table 76, each of numerical values of the multiplier T is registered in association with the number of articles. For example, the number of articles is 30 in the state illustrated in FIG. 5, and thus one third of the value is set as the multiplier T. Therefore, in a case where a reference tilting direction is 0 degree and a tilting direction after that is 30 degrees, the amount of change is set to 30 degrees, and thus the amount of correction is set to 10 degrees.

Meanwhile, in the example according to the fifth embodiment described above, the number of articles to be displayed on the display unit is fixed, but is not particularly limited thereto. For example, a user may arbitrarily set the number of articles. Specifically, the user may select articles that the user desires to display, from among displayable articles. The selected articles are displayed on the display unit in accordance with the number of articles selected.

In addition, in the example according to the fifth embodiment described above, the indicating direction is corrected by the correction process, but is not particularly limited as long as a relative positional relationship between the indicating direction and the plurality of articles can be corrected. For example, correction to shift the arrangement positions of the plurality of articles may be performed without changing the indicating direction. In addition, both the correction of the indicating direction and the correction for shifting the arrangement positions of the plurality of articles may be performed in accordance with the amount of correction.

### Sixth Embodiment

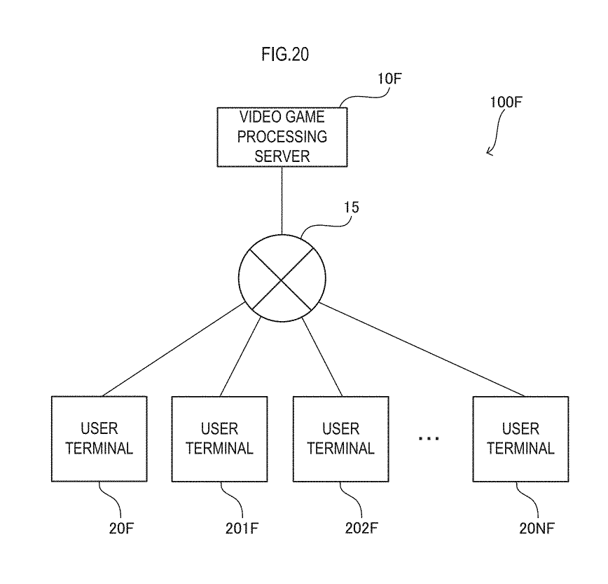

FIG. 20 is a block diagram illustrating an example of a configuration of a video game processing system 100F which is an example of the article selection processing system 100.

As illustrated in FIG. 20, the video game processing system 100F includes a video game processing server 10F which is an example of the processing server 10, and user terminals 20F and 201F to 20NF which are examples of the user terminals 20 and 201 to 20N. The user terminals 20F and 201F to 20NF are used by a plurality of users (players) who play a video game.

The video game processing server 10F and the plurality of user terminals 20F and 201F to 20NF are connected to a communication network 15 such as the Internet. Meanwhile, a configuration of the video game processing system 100F is not limited thereto. For example, a configuration in which a plurality of users use a single user terminal or a configuration in which a plurality of video game processing servers are provided may be adopted. In addition, the video game processing system 100F may also be constituted by only user terminals not including a game processing server.

The video game processing system 100F has various functions of executing a video game including a game in which each of a plurality of users operates a player object, for example, in the same (common) three-dimensional game space (synchronized virtual space), in addition to various functions of selecting one article from among a plurality of articles on the basis of operation information. The state of the game space captured by a virtual camera is displayed on display units of the user terminals 20F and 201F to 20NF as a game image.

In the video game in the example according to this embodiment, a game image including a plurality of articles is displayed on the display unit in accordance with a predetermined operation of displaying an article during the execution of the video game. The user can select one article by tilting an operation unit. For example, a motion to be performed on the player object is associated with each of the plurality of articles. Examples of the motion include greeting, hand-waving, and the like.

The video game processing server 10F is managed by a manager of the video game processing system 100F, and has various functions for providing information regarding the video game to the user terminals 20F and 201F to 20NF. For example, the video game processing server receives positional information of the player object of each user, and the like from the user (user terminal), and provides information (positional information of the other player objects, and the like) regarding the video game for proceeding with the game in the user terminals 20F and 201F to 20NF to the user terminals 20F and 201F to 20NF. The video game processing server 10F is constituted by an information processing device such as a WWW server in order to provide information regarding the video game and includes a database storing various information. However, this configuration is a general configuration, and thus a description thereof will be omitted here.

Each of the plurality of user terminals 20F and 201F to 20NF is managed by a user who plays a video game. Each of the user terminals 20F and 201F to 20NF is constituted by a communication terminal, such as a stationary game device or a personal computer, in which an online game can be played.

Each of the user terminals 20F and 201F to 20NF includes a plurality of operation devices (operation units), a storage unit such as an HDD, a control unit which is constituted by a CPU or the like which executes a game and generates a game image, a display device (display unit) that displays the game image, and the like in order to execute a video game, but a detailed description thereof will be omitted. In addition, in the user terminals 20F and 201F to 20NF, software (game programs) for executing a video game in the example according to an embodiment of the present invention and controlling the progress of the game is stored in the storage unit. Meanwhile, a program for selecting one article from among a plurality of articles is also included in the game programs.

The operation unit of each of the user terminals 20F and 201F to 20NF is, for example, the game pad 70 for a video game as illustrated in FIG. 6A described in the first embodiment.

An operation stick 73A can be tilted in any direction as illustrated in FIG. 6C. In addition, the operation stick 73A is set to be an erected state (neutral state) in a state where the tilting operation thereof is canceled as illustrated in FIG. 6B. For example, in FIG. 6A, the tilting direction of the operation stick 73A upward the game pad 70 is set to 0 degree, and a clockwise round (arrow Q) is set to 360 degrees, whereby numerical information of an angle is set to be information of the tilting direction of the operation stick 73A. That is, in a case where the tilting direction is 0 degree, it is indicated that the operation stick 73A is tilted upward the game pad 70 in FIG. 6A. Meanwhile, an operation stick 73B also has the same configuration.

The user terminals 20F and 201F to 20NF receive pieces of operation information including the amount of tilting and a tilting direction of each of the tilting operations of the respective operation sticks 73A and 73B, the turn-on/turn-off of a button 74, and the like from the operation units thereof. The amount of tilting and the tilting direction are the amount of tilting and a tilting direction based on the neutral state of each of the operation sticks 73A and 73B. Meanwhile, the detection of the pieces of operation information of the game pad 70 such as the amount of tilting and the tilting direction is a general configuration using a sensor and the like, and thus a detailed description thereof will be omitted.

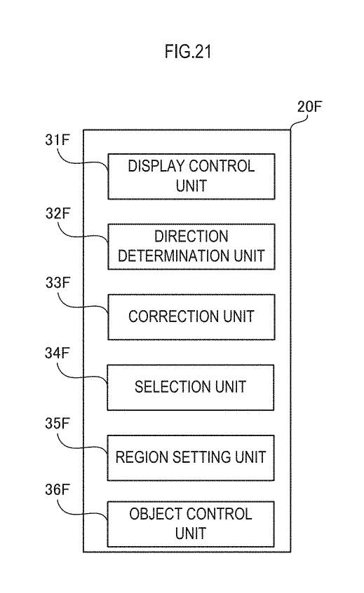

Next, a configuration of the user terminal 20F will be described. FIG. 21 is a functional block diagram illustrating a configuration of the user terminal 20F which is an example of the user terminal 20. The user terminal 20F includes at least a display control unit 31F, a direction determination unit 32F, a correction unit 33F, a selection unit 34F, a region setting unit 35F, and an object control unit 36F for causing the control unit to execute a game program stored in the storage unit and select one article from among a plurality of articles during the execution of a video game. Meanwhile, the other user terminals 201F to 20NF have the same configuration, and thus a description thereof will be omitted there.

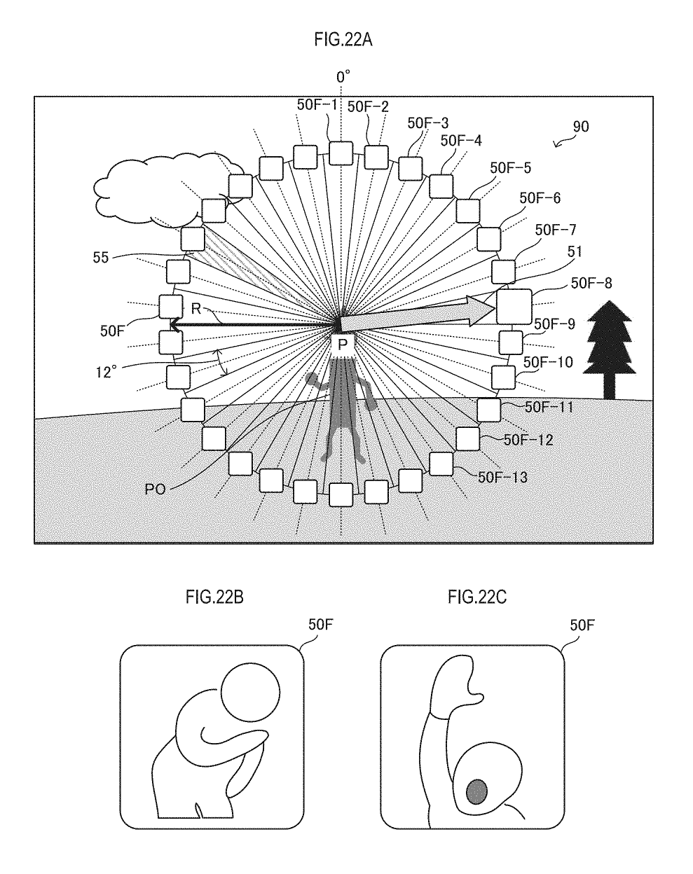

As illustrated in FIG. 22A, the display control unit 31F displays a game image including a plurality of articles 50F (command menu 90) which are disposed along the circumferential direction with respect to a reference position P of a screen coordinate system on the display unit of the user terminal 20F. FIG. 22A is a diagram illustrating an example of a list image of the plurality of articles 50F displayed on the display unit of the user terminal 20F. The command menu 90 has a ring shape by the plurality of articles 50F disposed along the circumferential direction of a radius R. The command menu 90 is compositely displayed on an image of a game space in which a player object PO is present. In addition, in the example according to this embodiment, the plurality of articles 50F are displayed in a state of being disposed at equal intervals, as illustrated in FIG. 22A.

An image showing the articles 50F in the example according to this embodiment is a rectangular icon image including a figure by which the type of motion associated with the article 50F can be specified, as illustrated in FIGS. 22B and 22C. FIG. 22B illustrates an article 50F of an icon image for causing the player object PO to perform a greeting motion. FIG. 22C illustrates an article 50F of an icon image for causing the player object PO to perform a motion of hand-waving.

In addition, each article 50F is positioned on a central direction CC which is a direction passing through the center of the separate region 55, as illustrated in FIG. 22A. The separate regions 55 are fan-like regions obtained by equally dividing a circular region having the radius R based on the reference position P in the screen coordinate system in the circumferential direction. In addition, the number of separate regions 55 is set corresponding to the number of articles 50F displayed on the display unit. The separate regions 55 are set by the region setting unit 35F. Meanwhile, the separate regions 55 and the central direction CC are displayed in FIG. 22A for convenience of description, but are not displayed on the actual display unit.

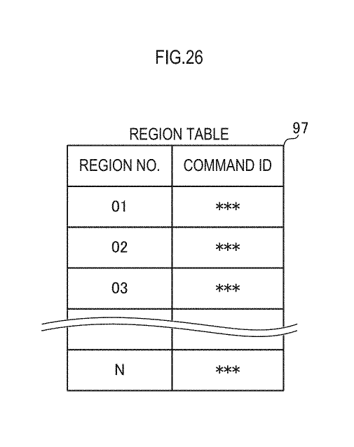

The region setting unit 35F sets the separate regions 55 based on the number of articles. For example, in a case where the number of articles is 30 as illustrated in FIG. 22A, 30 separate regions 55 are set. One separate region 55 is a region in which a central angle obtained by dividing the circular region having the radius R based on the reference position P into 30 parts is 12 degrees. A shaded region in FIG. 22A illustrates one separate region 55. In addition, the region setting unit 35F generates a region table 97 (see FIG. 26). The region table 97 is a table in which a correspondence relationship between the separate region 55 and the article is specified. The region table 97 will be described later.

In addition, the display control unit 31F displays the select beam 51 on the display unit. The select beam 51 is an image for specifying an indicating direction extending from the reference position P. Further, the display control unit 31F displays the article 50F indicated by the select beam 51 (indicating direction) in an enlarged manner. In FIG. 22A, an article 50F-8 indicated by the select beam 51 is displayed in a more enlarged state than the other articles 50F.

Meanwhile, in the example according to this embodiment, similar to the tilting direction of the operation stick 73A, as illustrated in FIG. 22A, a direction upward from the reference position P is set to 0 degree, and a clockwise round is set to 360 degrees, whereby a direction from the reference position P is specified as numerical information of an angle.

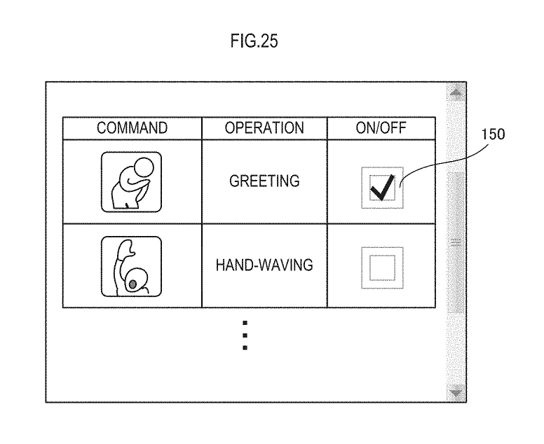

In addition, the display control unit 31F displays a registration screen (see FIG. 25) of a command (article 50F), which is displayed in the command menu 90, on the display unit. Details thereof will be described later.

Next, in a case where the amount of tilting of the operation stick 73A is less than the predetermined threshold value, the direction determination unit 32F determines an indicating direction on the basis of the tilting direction. In the example according to this embodiment, the direction determination unit 32F determines any one of the central directions CC of the respective separate regions 55 to be an indicating direction, on the basis of the tilting direction of the operation stick 73. For example, the direction determination unit 32F specifies in which separate region 55 a direction in the screen coordinate system based on the tilting direction is included, and determines the central direction CC of the separate region 55 including the direction to be an indicating direction. Meanwhile, the display control unit 31F displays the select beam 51 extending from the reference position P along the indicating direction on the display unit after the indicating direction is determined.

In a case where the amount of tilting is equal to or greater than the predetermined threshold value, the correction unit 33F determines the amount of correction and corrects the indicating direction. In the example according to this embodiment, the correction unit 33F corrects the indicating direction determined by the direction determination unit 32F (direction determination process) so that the indicating direction is rotated either clockwise or counterclockwise on the basis of the reference position P. At this time, the correction unit 33F specifies in which separate region 55 a direction in which the indicating direction is corrected in accordance with the amount of correction is included, and sets the central direction CC of the separate region 55 including the direction to be an indicating direction.

In addition, the amount of correction in the example according to this embodiment is determined by Expression (2). Meanwhile, in the example according to this embodiment, the tilting direction is numerical information of an angle, and thus the amount of change in the tilting direction also serves as numerical information of the amount of change in the angle. In addition, the amount of correction is the amount of correction of the angle and serves as numerical information.

Amount of Correction=Amount of Change×(360/N×E)/S (2)

N: The number of articles displayed

E: The number of articles adjusted

S: tilting range (angle) of operation stick 73

The number of articles displayed (N) means the number of articles 50F displayed on the display unit. A central angle of one separate region 55 corresponding to one article 50F is calculated using the number of articles displayed (N). The number of articles adjusted (E) means the number of articles (the number of articles easily selected) which is suitable for fine adjustment from the article 50F which is currently indicated. For example, it means that five articles up to an article 50F-13 disposed in a clockwise direction and five articles up to an article 50F-3 disposed in a counterclockwise direction from the article 50F-8 are suitable for fine adjustment when E=5 in a state where the article 50F-8 illustrated in FIG. 22A is indicated.

The tilting range (S) of the operation stick 73A means a tilting range of the operation stick 73A which is necessary for fine adjustment (correction of an indicating direction) of the number of articles adjusted (E). For example, the operation stick 73A in a tilted state is rotated clockwise by 90 degrees from a reference tilting direction when E=5 and S=90 degrees in a state where the article 50F-8 illustrated in FIG. 22A is indicated, and thus the amount of correction is calculated so that the article 50F-13 is indicated, thereby correcting (fine adjustment) the indicating direction. That is, the amount of correction is set to 60 degrees with the amount of change of 90 degrees. Meanwhile, numerical values of the number of articles adjusted (E) and the tilting range (S) of the operation stick 73 can be arbitrarily set. In addition, the number of articles adjusted (E) and the tilting range (S) of the operation stick 73 are included in game data of the game program as fixed values, but a user may be able to adjust the values.

In addition, the number of articles displayed (N) of the articles 50F displayed on the display unit is also included in Expression (2), and thus the amount of correction also changes depending on a change in the number of articles displayed (N). In more detail, as the number of articles 50F displayed increases, the amount of correction for the same amount of change also decreases. In this embodiment, the articles 50F are disposed along the circumferential direction at equal intervals, and thus an interval between the articles 50F disposed decreases as the number of articles displayed (N) increases. Therefore, the amount of correction for the same amount of change decreases as the number of articles displayed (N) increases, and thus fine adjustment is easily performed. On the other hand, an interval between the articles 50F disposed increases as the number of articles displayed (N) decreases, and thus fine adjustment is easily performed when the amount of correction for the same amount of change increases.

In a case where the amount of tilting is equal to or greater than the predetermined threshold value, the selection unit 34F selects the article 50F indicated by an indicating direction. In the example according to this embodiment, the selection unit 34F selects the article 50F associated with the separate region 55 including the indicating direction. That is, the article 50F, displayed in an enlarged manner, which is indicated by the select beam 51 is selected. In more detail, the selection unit 34F specifies the separate region 55 including the indicating direction, and specifies the article 50F associated with the specified separate region 55 with reference to the region table 97 to be described later.

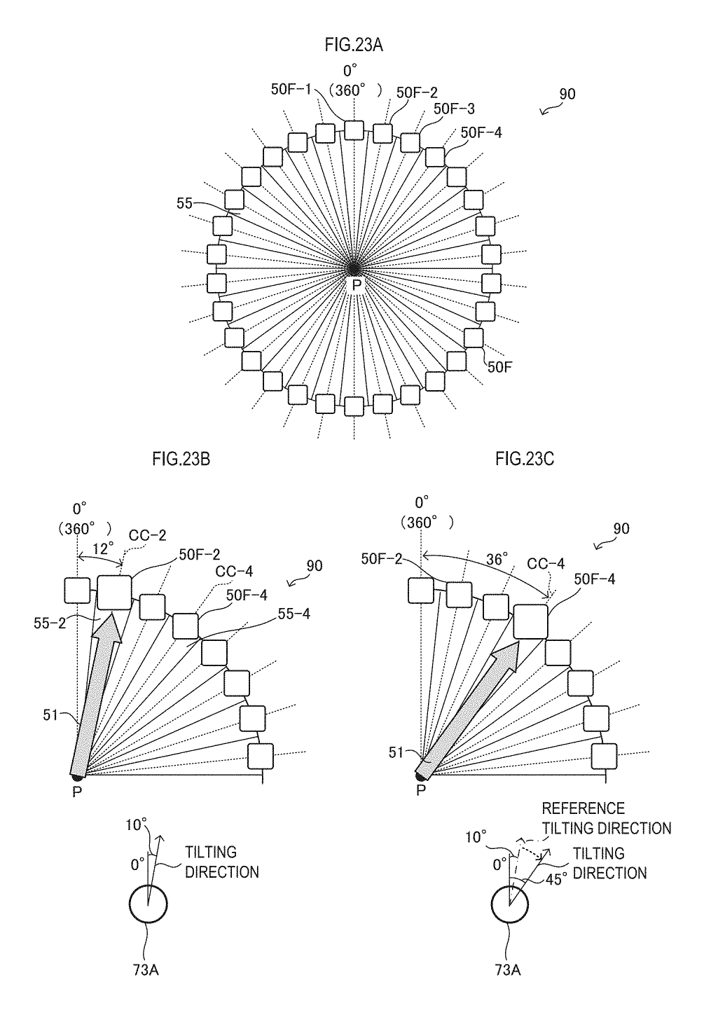

Next, a case where an article 50F-4 illustrated in FIGS. 23A to 23C is selected by tilting the operation stick 73A will be described. FIGS. 23A to 23C are diagrams illustrating an example of a list image (command menu 90) of the plurality of articles 50F displayed on the display unit of the user terminal 20F. FIG. 23A illustrates a non-display state of the select beam 51 before a tilting operation is started. FIG. 23B illustrates a state where a tilting operation is started and an indicating direction is determined in the direction determination process. FIG. 23C illustrates a state where an indicating direction (select beam 51) is corrected (fine adjustment) in a correction process.

Meanwhile, a description will be given on the assumption that the number of articles displayed (N)=30, the number of articles adjusted (E)=5, and the tilting range of operation stick 73 (S)=90. In addition, a command menu 90 illustrated in FIG. 23A has the same configuration as that of the command menu 90 illustrated in FIG. 22A, and a portion of the display is omitted for convenience of description. In addition, similarly to FIG. 22A, the separate regions 55 and the central directions CC are illustrated in FIG. 23A, but are not actually displayed on the display unit.

A user starts a tilting operation of the operation stick 73A, for example, in a direction of 10 degrees (tilting direction). Thereby, the state illustrated in FIG. 23A transitions to a state illustrated in FIG. 23B in which the select beam 51 is displayed. At this time, a direction from the reference position P based on the tilting direction of 10 degrees is included in a separate region 55-2. For this reason, an indicating direction is determined to be a central direction CC-2 (indicating direction: 12 degrees) of the separate region 55-2. The select beam 51 along the central direction CC-2 is displayed. In addition, an article 50F-2 indicated by the indicating direction (select beam 51) is displayed in an enlarged manner.

Thereafter, in a case where the operation stick 73A is further tilted while maintaining the tilting direction of 10 degrees and the amount of tilting of the operation stick 73A is set to equal to or greater than a threshold value, the indicating direction is corrected in accordance with the amount of change from the tilting direction (reference tilting direction) of 10 degrees. The article 50F-2 is indicated in the state illustrated in FIG. 23B, and thus a user may perform fine adjustment by rotating the operation stick 73A clockwise. That is, the indicating direction is corrected so as to indicate an article 50F-4.

In a case where the tilting direction of 10 degrees (reference tilting direction) is changed to the tilting direction of 45 degrees by rotating the operation stick 73A clockwise, the amount of change is set to 30 degrees. In addition, the amount of correction is set to 20 degrees by using Expression (2). Since the present indicating direction is 12 degrees, a central direction CC-4 of a separate region 55-4 including a direction of 32 degrees obtained by the addition of the amount of correction of 30 degrees is set to be a corrected indicating direction (indicating direction: 36 degrees). As illustrated in FIG. 23C, the display of the select beam 51 is also changed along the central direction CC-4. In addition, the article 50F-4 indicated by the indicating direction (select beam 51) is displayed in an enlarged manner.

Meanwhile, in a case where there is a desire of further performing fine adjustment from the article 50F-4 illustrated in FIG. 23C, the operation stick 73A may be further rotated clockwise or counterclockwise. The selection of the article 55F of the separate region 55 including an indicating direction (select beam 51) at a point in time of the operation of a determination button is fixedly set.

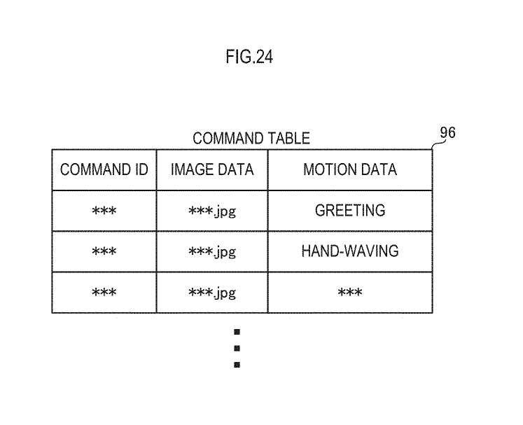

Next, the object control unit 36F will be described. The object control unit 36 controls the motion of the player object PO. In the example according to this embodiment, the object control unit 36F causes the player object PO to execute a motion corresponding to the article 50F selected by the selection unit 35F. The object control unit 36F causes the player object PO to execute a motion, for example, with reference to a command table 96 illustrated in FIG. 24.

FIG. 24 is a diagram illustrating an example of the command table 96. In the command table 96, image data and motion data associated with a command ID are registered. The command ID is specific identification information attached to each command (article 50F). The image data is information for specifying an icon image of the article 50F corresponding to a command (command ID). For example, an image file name is registered. The motion data is information for specifying contents of a motion which correspond to the command (command ID). For example, an operation ID indicating identification information of a motion is registered. Meanwhile, in FIG. 24, contents of a motion are displayed in the motion data for convenience of description. In addition, the command table 96 is included in the game data.

In the example according to this embodiment, a user can register the article 50F desired to be displayed as the command menu 90 from among commands (articles 50F) registered in the command table 96. For example, in a registration screen as illustrated in FIG. 25 which is displayed on the basis of the command table 96, the article 50F may be registered (selected) by operation of the game pad 70. In more detail, the determination button (not shown) is operated after a check box 150 set for each article 50F is checked, thereby completing registration of the checked article 50F in the command menu 90. Meanwhile, FIG. 25 illustrates a state where a portion of the articles 50F registered in the command table 96 is displayed. For example, the scrolling of the screen is performed, thereby displaying even the article 50F which is not currently displayed.

When the registration is completed, the region setting unit 35F generates the region table 97 as illustrated in FIG. 26 on the basis of the registration result. In the region table 97, information of the article 50F displayed in the command menu 90 is registered. Specifically, a command ID is registered in association with a region number. The command ID is a command ID corresponding to a command (article 50F) selected (registered) by the user.

The region number is identification information of the separate region 55. In the example according to this embodiment, region numbers are set clockwise in order by setting a separate region 55-1 including a direction of 0 degree from the reference position P to be a region number 01. Therefore, the region numbers corresponding to the number of articles displayed (N) are registered. That is, in the region table 97, the articles 50F and the separate regions 55 displayed in the command menu 90 are associated with each other on a one-to-one basis. For example, the command ID corresponding to the article 50F selected (registered) by the user are registered from the region number: 01 in descending order. Meanwhile, the region table 97 is stored in the storage unit of the user terminal 20F.

Meanwhile, the display control unit 31F displays the command menu 90 with reference to the command table 96 and the region table 97.

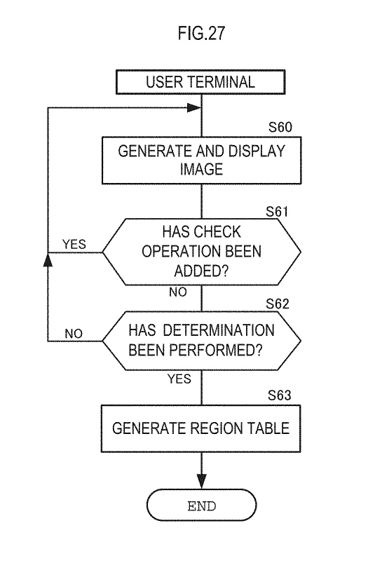

Next, a registration process of the article 50F mentioned above will be described with reference to FIG. 27. FIG. 27 is a flow chart illustrating an example of a registration process performed by the video game processing system 100F. In the registration process according to this example, a process of registering the article 50F selected by a user as an article 50F to be displayed in the command menu 90 is performed. Hereinafter, an example of a case where the user terminal 20F performs the registration process will be described.

The registration process according to this example is performed, for example, in a case where an operation of performing command registration of the game pad 70 is performed. Meanwhile, in a case where the registration is canceled, the process may be forcibly terminated.

In the registration process, the user terminal 20F generates an image of the registration screen as illustrated in FIG. 25 on the basis of the command table 96 and displays the generated image on the display unit (step S60). Next, the user terminal 20F determines whether or not a new check operation has been performed (step S61). In a case where it is determined that the check operation has been performed (step S61: YES), the user terminal 20F returns to the processing of step S60 to update the registration screen. That is, a check mark is added to the check box 150 for which a check operation has been performed. On the other hand, in a case where it is determined that the check operation has not been performed (step S61: NO), the user terminal 20F determines whether or not the determination of registration has been performed (step S62). In a case where it is determined that the determination of registration has been performed (step S62: YES), the user terminal 20F generates the region table 97 (step S63) and terminates the registration process. In the processing of step S63, the region table 97 is generated with respect to the article 50F (command ID) for which a check mark is added to the check box 150, and the generated region table is stored in the storage unit of the user terminal 20F. In addition, in a case where it is determined that the determination of registration has not been performed (step S62: NO), the user terminal 20F returns to the processing of step S60.

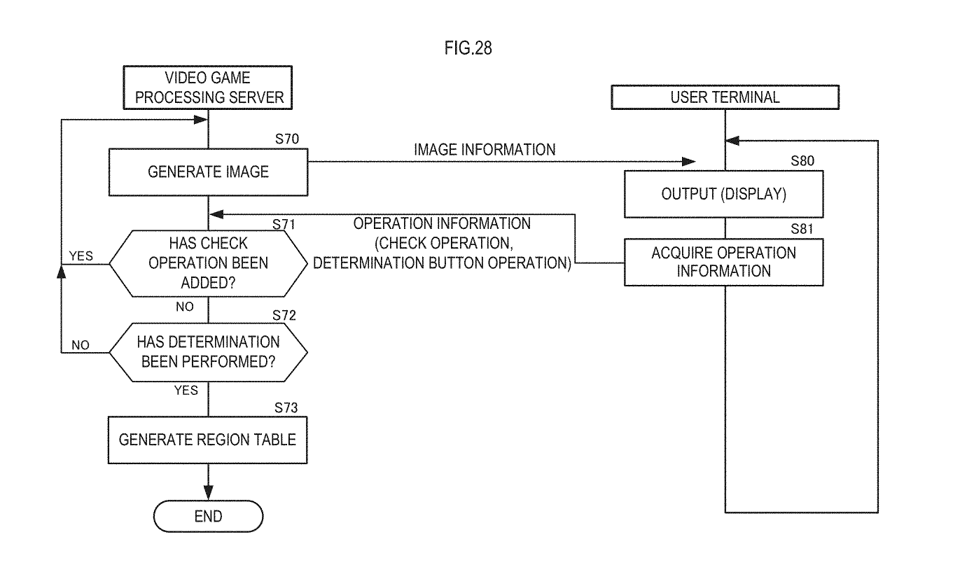

Meanwhile, the registration process may be performed by the video game processing server 10F instead of the user terminal 20F. FIG. 28 is a flow chart illustrating an example of operations of the video game processing server 10F (server 10F) and the user terminal 20F in a case where the video game processing server 10F performs the registration process illustrated in FIG. 27. In the registration process, the server 10F generates an image of a registration screen (step S70). The server 10F transmits the generated image information to the user terminal 20F. The user terminal 20F displays an image based on the received image information on the display unit (step S80). That is, the registration screen is displayed on the display unit. In addition, the user terminal 20F acquires operation information of the operation unit (game pad 70) (step S81), and transmits the acquired operation information to the server 10F. The operation information includes information regarding a check operation and the operation of the determination button.

Next, the server 10F determines whether or not a new check operation has been performed, on the basis of the received operation information (step S71). In a case where it is determined that the check operation has been performed (step S71: YES), the server 10F returns to the processing of step S70 to update the registration screen. On the other hand, in a case where it is determined that the check operation has not been performed (step S71: NO), the server 10F determines whether or not the determination of registration has been performed, on the basis of the received operation information (step S72). In a case where it is determined that the determination of registration has been performed (step S72: YES), the server 10F generates the region table 97 (step S73) and terminates the registration process. In addition, in a case where it is determined that the determination of registration has not been performed (step S72: NO), the server 10F returns to the processing of step S70.

Meanwhile, in a case of the processing illustrated in FIG. 28, the generated region table 97 may be stored in the storage unit of the server 10F, for example, in association with user identification information. Alternatively, the generated region table may be transmitted to the user terminal 20F from the server 10F and may be stored in the storage unit of the user terminal 20F.

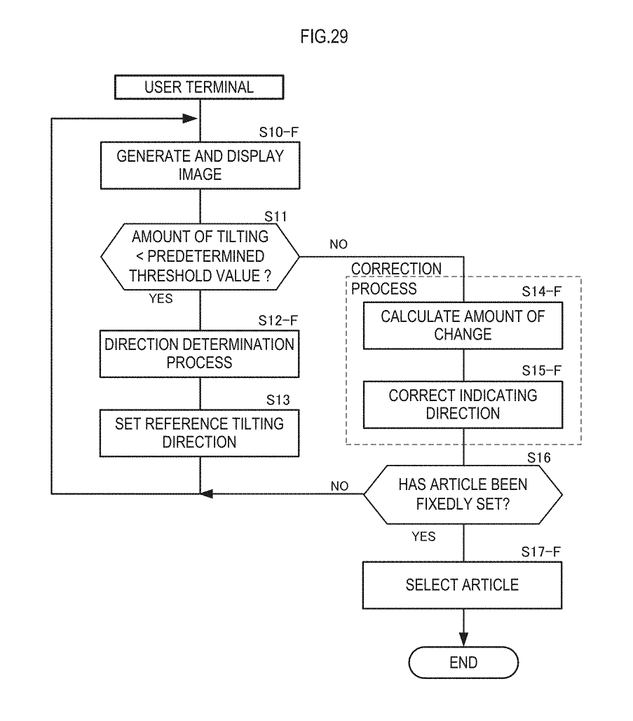

Next, a selection process will be described with reference to FIG. 29. FIG. 29 is a flow chart illustrating an example of a selection process performed by the video game processing system 100F. In the selection process according to this example, a process of selecting one article 50F from among the plurality of articles 50F displayed on the display unit is performed. Hereinafter, an example of a case where the user terminal 20F performs a selection process will be described. Meanwhile, a description of a flow chart illustrating the operation of the video game processing server 10F will be omitted from the viewpoint of avoiding a repeated description.

For example, the selection process in this example is performed in a case where an operation of the game pad 70 for displaying articles is performed. Meanwhile, in a case where the selection of an article is canceled, the process may be forcibly terminated.

In the selection process, the user terminal 20F generates a game image including an image of the command menu 90 as illustrated in FIG. 22A and displays the generated game image on the display unit (step S10-F). The user terminal 20F generates the image of the command menu 90 on the basis of the command table 96 and the region table 97. In addition, in a case where an indicating direction is determined, the select beam 51 based on the indicating direction is displayed, and an image of the article 50F indicated by the select beam 51 (indicating direction) is displayed in a more enlarged state than the other articles 50F.

Next, the user terminal 20F determines whether or not the amount of tilting of the operation stick 73A is less than the predetermined threshold value (step S11). In a case where it is determined that the amount of tilting is less than the predetermined threshold value (step S11: YES), the user terminal 20F performs a direction determination process of determining an indicating direction (step S12-F). In the direction determination process, any one of the central directions CC of the respective separate regions 55 is determined to be an indicating direction on the basis of the tilting direction of the operation stick 73A as described above.

Next, the user terminal 20F sets (updates) the tilting direction at the time of the determination of the indicating direction as a reference tilting direction (step S13).

Thereafter, the user terminal 20F returns to the processing of step S10-F. The user terminal returns to the processing of step S10-F to update the game image. For example, the user terminal 20F displays the game image inclusive of the select beam 51 and the like based on the determined indicating direction.

On the other hand, in a case where it is determined in the processing of step S11 that the amount of tilting is not less than the predetermined threshold value, the user terminal 20F performs a correction process of correcting the indicating direction (steps S14-F and S15-F). Specifically, first, the user terminal 20F calculates the amount of change in the tilting direction with respect to the reference tilting direction of the operation stick 73A (step S14-F). Thereafter, the user terminal 20F calculates the amount of correction based on the amount of change to thereby correct the indicating direction (step S15-F). The user terminal 20F calculates the amount of correction by using Expression (2) as described above. Meanwhile, as the number of articles displayed (N), the region numbers of the region table 97 may be referred to. The user terminal 20F specifies in which separate region 55 a direction in which the indicating direction determined in the direction determination process is corrected in accordance with the amount of correction is included, and sets the central direction CC of the separate region 55 including the direction to be an indicating direction.

Thereafter, the user terminal 20F determines whether or not an article corresponding to the indicating direction has been selected (fixedly set) (step S16). In a case where the article has been fixedly set (step S16: YES), the user terminal 20F selects the article 50F associated with the separate region 55 including the indicating direction (select beam 51) (step S17-F) and terminates the selection process. Specifically, the article 50F associated with the separate region 55 is specified with reference to the region table 97. On the other hand, in a case where the article has not been fixedly set (step S16: NO), the user terminal 20F returns to the processing of step S10-F to update the game image in accordance with correction results of the select beam 51 and the like, and continuously performs the direction determination process and the correction process in accordance with the amount of tilting.

After one article 50F is selected (fixedly set) by the above-described selection process, the user terminal 20F transmits motion information corresponding to the selected article 50F to the video game processing server 10F. The video game processing server 10F causes the player object PO corresponding to the game terminal 20F to execute a motion on the basis of the received motion information, generates image information of a virtual space, and transmits the generated image information to the user terminals 20F and 201F to 20NF. The user terminals 20F and 201F to 20NF display the game image on the display unit on the basis of the received image information.

As described above, as an aspect of the sixth embodiment, the user terminal 20F is configured to include the display control unit 31F, the direction determination unit 32F, the correction unit 33F, the selection unit 34F, the region setting unit 35F, and the object control unit 36F, and thus an indicating direction is determined in accordance with the tilting direction of the operation unit (operation stick 73A) and is then corrected. That is, fine adjustment of the indicating direction can be performed after the indicating direction is roughly determined on the basis of the tilting direction. Accordingly, even when one article 50F is selected from among a large number of articles 50F, one article 50F desired to be selected is easily indicated. Therefore, it is possible to improve user operability.

In addition, the indicating direction is set to be the central direction CC of the separate region 55, and thus a user indicates the article 50F more easily. In addition, the article 50F is also disposed on the central direction CC of the separate region 55, and thus the user easily recognizes the indicated article 50F. Moreover, the indicated article 50F is displayed in a more enlarged state than the other articles, and thus the user recognizes the indicated article 50F more easily.

Further, the plurality of articles 50F are displayed in a state of being disposed at equal intervals in accordance with the number of articles. In addition, the amount of correction is also determined in accordance with the number of articles in addition to the amount of change. Therefore, even when the user arbitrarily sets (changes) the number of articles 50F to be displayed, the visibility of the plurality of articles is maintained, and it is possible to maintain user operability.

Meanwhile, in the example according to the sixth embodiment described above, the indicating direction is corrected by the correction process, but is not particularly limited as long as a relative positional relationship between the indicating direction and the plurality of articles 50F can be corrected. For example, correction to shift the arrangement positions of the plurality of articles 50F may be performed without changing the determined indicating direction (display of the select beam 51). For example, the arrangement positions of the plurality of articles 50F are shifted (rotationally moved) clockwise or counterclockwise in accordance with the amount of correction without changing the indicating direction (select beam 51) in a state where the select beam 51 of FIG. 23B is displayed. Alternatively, both the correction of the indicating direction and the correction for shifting the arrangement positions of the plurality of articles may be performed in accordance with the amount of correction.

In addition, in the example according to the sixth embodiment described above, a motion executed by the player object PO is described as the article 50F, but is not particularly limited thereto. For example, an item possessed by a user (player object) may be associated with an article. The article is selected, and thus the player object uses the corresponding possessed item.

Further, in the example according to the sixth embodiment described above, the display of the select beam 51 based on an indicating direction and the enlarged display of the article 50F indicated by the indicating direction are performed, but only any one of the displays may be performed. In addition, a display mode of the article 50F indicated by the indicating direction is not limited to only enlarged display. Any configuration may be adopted as long as the display mode for specifying the article 50F indicated by the indicating direction. For example, the color of display of the article 50F indicated by the indicating direction may be made different from the color of display of the other articles 50F.

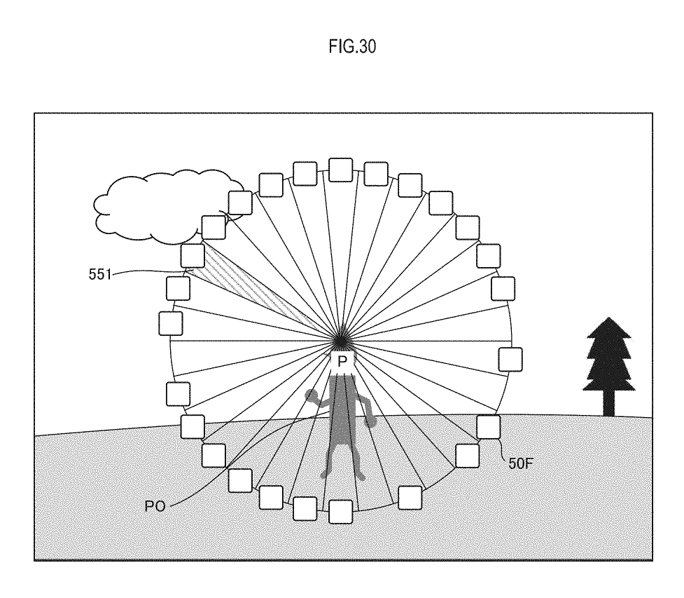

In addition, in the example according to the sixth embodiment described above, the separate regions 55 are set in accordance with the number of articles (the number of articles displayed (N)), but the number of separate regions 55 may be fixed. For example, as illustrated in FIG. 30, when the number of separate regions 551 is fixed to 30 and the number of commands registered (the number of articles) is less than 30, an article may not be set in a portion of the separate regions 551. FIG. 30 illustrates a state where 25 articles 50F are displayed. In this case, in the region table 97, the number of region numbers is fixed to 30, but information having a command ID not set therein may be set in a separate region (region number) which is not associated with an article (command ID). In this case, it is preferable that the number of articles displayed (N) in Expression (2) is fixed to 30.

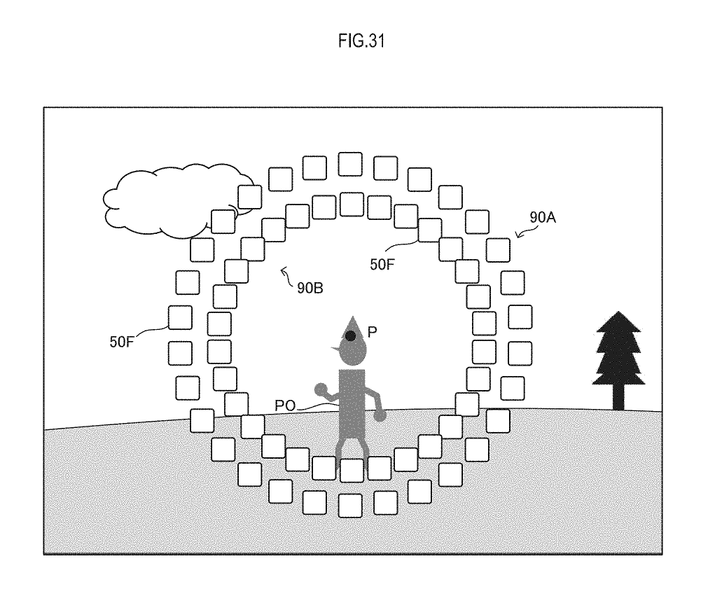

Further, in the example according to the sixth embodiment described above, one ring-shaped command menu 90 is displayed, but a plurality of command menus may be displayed. For example, as illustrated in FIG. 31, command menus 90A and 90B having articles 50F disposed in circumferential directions of circles having different radiuses based on the same reference position P may be displayed. In this case, for example, the selection of the article 50F may be performed by tilting an operation stick after selecting the command menus 90A and 90B to be operated by the operation of the game pad 70.

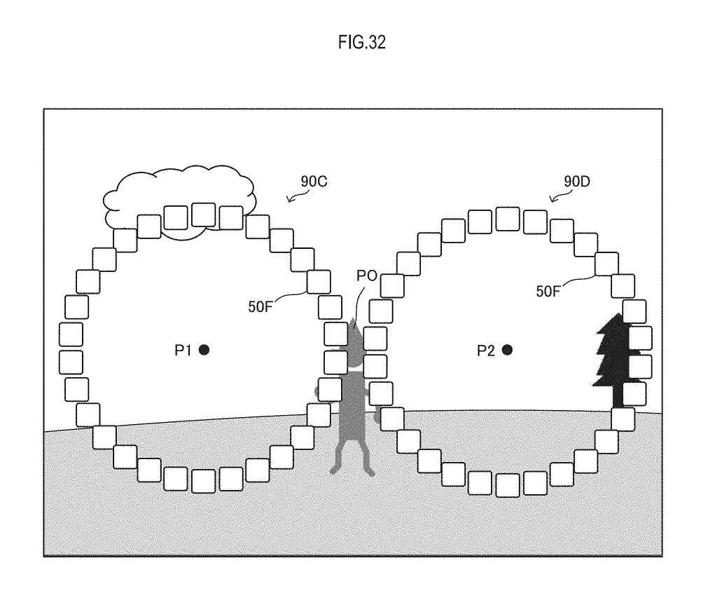

Alternatively, as illustrated in FIG. 32, command menus 90C and 90D having articles 50F disposed in circumferential directions of circles having the same radius based on two reference positions P1 and P2 may be displayed. In this case, for example, the selection of the articles 50F of the command menus 90C and 90D may be performed by a tilting operation of each of the operation sticks 73A and 73B. In addition, the ring-shaped command menu 90 is not limited to having a circular shape, and may have an elliptical shape or a rectangular shape.

In addition, a boundary between separate regions in the example according to the sixth embodiment described above may be set to be included in any one of two adjacent separate regions.

In the examples of the above-described embodiments, the selection unit is configured to select an article indicated by an indicating direction in a case where the amount of tilting is equal to or greater than a predetermined threshold value, but is not limited thereto. For example, the article may be selected in a case where the amount of tilting is less than the predetermined threshold value.

### Appendixes

The above embodiments have been described so that a person skilled in the art can implement at least the following inventions.

[1]

A program causing a computer to realize a function of receiving operation information of an operation unit tilted in any direction and selecting one article from among a plurality of articles displayed on a display unit on the basis of the operation information, the program causing the computer to execute:

a display control function of displaying the plurality of articles, which are disposed along a predetermined direction with respect to a reference position in a screen coordinate system of the display unit, on the display unit;

a direction determination function of determining an indicating direction indicating the one article from the reference position, on the basis of a tilting direction of the operation unit which is included in the operation information in a case where an amount of tilting of the operation unit which is included in the operation information is less than the predetermined threshold value;

a correction function of determining an amount of correction on the basis of an amount of change in the tilting direction based on the tilting direction at a time of the determination of the indicating direction in a case where the amount of tilting is equal to or greater than the predetermined threshold value, and performing at least one of correction of the indicating direction and correction to shift arrangement positions of the plurality of articles along the predetermined direction in accordance with the amount of correction; and

a selection function of selecting an article indicated by the indicating direction in a case where the amount of tilting is equal to or greater than the predetermined threshold value.

[2]

The program according to [1], causing the computer to further execute:

a region setting function of setting separate regions obtained by dividing a range capable of being indicated from the reference position in the predetermined direction, and associating one of the plurality of articles with each of the separate regions,

wherein the display control function realizes a function of displaying the article associated with a position corresponding to each of the separate regions, and

the selection function realizes a function of selecting the article associated with the separate region including the indicating direction.

[3]

The program according to [2],

wherein the display control function realizes a function of disposing the article associated with the separate region on a central direction which is a direction passing through a center of the separate region from the reference position and displaying the article on the display unit,

the direction determination function realizes a function of determining any one of the central directions of the respective separate regions to be the indicating direction on the basis of the tilting direction, and

the correction function realizes a function of correcting the determined indicating direction to any one of the central directions of the respective separate regions, as the correction of the indicating direction.

[4]

The program according to [2] or [3],

wherein the display control function realizes a function of disposing the article associated with the separate region on a central direction which is a direction passing through a center of the separate region from the reference position and displaying the article on the display unit,

the direction determination function realizes a function of determining any one of the central directions of the respective separate regions to be the indicating direction on the basis of the tilting direction, and

the correction function realizes a function of shifting the arrangement positions of the plurality of articles on any one of the central directions of the respective separate regions along the predetermined direction, as the correction to shift the arrangement positions of the plurality of articles.

[5]

The program according to any one of [1] to [4],

wherein the display control function realizes a function of disposing the plurality of articles at equal intervals and displaying the articles on the display unit, on the basis of the number of plurality of articles, and

the correction function realizes a function of determining the amount of correction on the basis of the amount of change and the number of articles.

[6]

The program according to any one of [1] to [5],

wherein the display control function realizes a function of displaying the plurality of articles disposed along a circumferential direction based on the reference position on the display unit, and

the correction function realizes a function of performing at least one of correction of the indicating direction in a clockwise or counterclockwise direction based on the reference position and correction to shift the arrangement positions of the plurality of articles in the clockwise or counterclockwise direction, in accordance with the amount of correction.

[7]

The program according to any one of [1] to [6],

wherein the display control function realizes a function of displaying an indicating image for specifying the indicating direction on the display unit in a case where the amount of tilting is equal to or greater than the predetermined threshold value.

[8]

The program according to any one of [1] to [7],

wherein the display control function realizes a function of displaying the article in a display mode for specifying the article indicated by the indicating direction in a case where the amount of tilting is equal to or greater than the predetermined threshold value.

[9]

The program according to any one of [1] to [8],

wherein the display control function realizes a function of displaying the article by an icon image capable of specifying contents of the article.

[10]

The program according to any one of [1] to [9],

wherein the operation unit includes an operation stick which is capable of being tilted in any direction and returns to an erected state by cancelling the tilting.

[11]

The program according to any one of [1] to [10], causing the computer to further execute:

a function of controlling a motion of a player object in a game space on the basis of the operation information of the operation unit to control progress of a video game and causing the player object to perform a motion associated with the article selected from among the plurality of articles.

[12]

A server device in which the program according to any one of [1] to [11] is installed.

[13]

A terminal program causing a terminal device to realize a function of displaying a plurality of articles on a display screen of a display unit and selecting one article from among the plurality of articles on the basis of operation information, the program causing the terminal device to execute:

a connection function of being connected to the server device according to [12] through a communication network.

[14]

A program causing a server device to select one article from among a plurality of articles displayed on a display unit of a terminal device on the basis of operation information of an operation unit tilted in any direction, the server device being connected to the terminal device receiving the operation information through a communication network, the program causing the server device to execute:

a display control function of displaying the plurality of articles, which are disposed along a predetermined direction with respect to a reference position in a screen coordinate system of the display unit, on the display unit;

a direction determination function of determining an indicating direction indicating the one article from the reference position, on the basis of a tilting direction of the operation unit which is included in the operation information in a case where an amount of tilting of the operation unit which is included in the operation information is less than the predetermined threshold value;

a correction function of determining an amount of correction on the basis of an amount of change in the tilting direction based on the tilting direction at a time of the determination of the indicating direction in a case where the amount of tilting is equal to or greater than the predetermined threshold value, and performing at least one of correction of the indicating direction and correction to shift arrangement positions of the plurality of articles along the predetermined direction in accordance with the amount of correction; and

a selection function of selecting an article indicated by the indicating direction in a case where the amount of tilting is equal to or greater than the predetermined threshold value.

[15]

The program according to [14], causing the computer to further execute:

a region setting function of setting separate regions obtained by dividing a range capable of being indicated from the reference position in the predetermined direction, and associating one of the plurality of articles with each of the separate regions,

wherein the display control function realizes a function of displaying the article associated with a position corresponding to each of the separate regions, and

the selection function realizes a function of selecting the article associated with the separate region including the indicating direction.

[16]

The program according to [15],

wherein the display control function realizes a function of disposing the article associated with the separate region on a central direction which is a direction passing through a center of the separate region from the reference position and displaying the article on the display unit,

the direction determination function realizes a function of determining any one of the central directions of the respective separate regions to be the indicating direction on the basis of the tilting direction, and

the correction function realizes a function of correcting the determined indicating direction to any one of the central directions of the respective separate regions, as the correction of the indicating direction.

[17]

The program according to [15] or [16],

wherein the display control function realizes a function of disposing the article associated with the separate region on a central direction which is a direction passing through a center of the separate region from the reference position and displaying the article on the display unit,

the direction determination function realizes a function of determining any one of the central directions of the respective separate regions to be the indicating direction on the basis of the tilting direction, and

the correction function realizes a function of shifting the arrangement positions of the plurality of articles on any one of the central directions of the respective separate regions along the predetermined direction, as the correction to shift the arrangement positions of the plurality of articles.

[18]

The program according to any one of [14] to [17],

wherein the display control function realizes a function of disposing the plurality of articles at equal intervals and displaying the articles on the display unit, on the basis of the number of plurality of articles, and

the correction function realizes a function of determining the amount of correction on the basis of the amount of change and the number of articles.

[19]

The program according to any one of [14] to [18],

wherein the display control function realizes a function of displaying the plurality of articles disposed along a circumferential direction based on the reference position on the display unit, and

the correction function realizes a function of performing at least one of correction of the indicating direction in a clockwise or counterclockwise direction based on the reference position and correction to shift the arrangement positions of the plurality of articles in the clockwise or counterclockwise direction, in accordance with the amount of correction.

[20]

The program according to any one of [14] to [19],

wherein the display control function realizes a function of displaying an indicating image for specifying the indicating direction on the display unit in a case where the amount of tilting is equal to or greater than the predetermined threshold value.

[21]

The program according to any one of [14] to [20],

wherein the display control function realizes a function of displaying the article in a display mode for specifying the article indicated by the indicating direction in a case where the amount of tilting is equal to or greater than the predetermined threshold value.

[22]

The program according to any one of [14] to [21],

wherein the display control function realizes a function of displaying the article by an icon image capable of specifying contents of the article.

[23]

The program according to any one of [14] to [22],

wherein the operation unit includes an operation stick which is capable of being tilted in any direction and returns to an erected state by cancelling the tilting.

[24]

The program according to any one of [14] to [23], causing the computer to further execute:

a function of controlling a motion of a player object in a game space on the basis of the operation information of the operation unit to control progress of a video game and causing the player object to perform a motion associated with the article selected from among the plurality of articles.

[25]

An article selection system including a terminal device that receives operation information of an operation unit tilted in any direction and a server device, connected to the terminal device through a communication network, which selects one article from among a plurality of articles displayed on a display unit of the terminal device on the basis of the operation information, the article selection system including:

a display controller that displays the plurality of articles, which are disposed along a predetermined direction with respect to a reference position in a screen coordinate system of the display unit, on the display unit;

a direction determiner that determines an indicating direction indicating the one article from the reference position, on the basis of a tilting direction of the operation unit which is included in the operation information in a case where an amount of tilting of the operation unit which is included in the operation information is less than the predetermined threshold value;

a corrector that determines an amount of correction on the basis of an amount of change in the tilting direction based on the tilting direction at a time of the determination of the indicating direction in a case where the amount of tilting is equal to or greater than the predetermined threshold value, and performs at least one of correction of the indicating direction and correction to shift arrangement positions of the plurality of articles along the predetermined direction in accordance with the amount of correction; and

a selector that selects an article indicated by the indicating direction in a case where the amount of tilting is equal to or greater than the predetermined threshold value.

[26]

The article selection system according to [25], further including:

a region setter that sets separate regions obtained by dividing a range capable of being indicated from the reference position in the predetermined direction, and associates one of the plurality of articles with each of the separate regions;

wherein the display controller displays the article associated with a position corresponding to each of the separate regions, and

the selector selects the article associated with the separate region including the indicating direction.

[27]

The article selection system according to [26],

wherein the display controller disposes the article associated with the separate region on a central direction which is a direction passing through a center of the separate region from the reference position and displays the article on the display unit,

the direction determiner determines any one of the central directions of the respective separate regions to be the indicating direction on the basis of the tilting direction, and

the corrector corrects the determined indicating direction to any one of the central directions of the respective separate regions, as the correction of the indicating direction.

[28]

The article selection system according to [26] or [27],

wherein the display controller disposes the article associated with the separate region on a central direction which is a direction passing through a center of the separate region from the reference position and displays the article on the display unit,

the direction determiner determines any one of the central directions of the respective separate regions to be the indicating direction on the basis of the tilting direction, and

the corrector shifts the arrangement positions of the plurality of articles on any one of the central directions of the respective separate regions along the predetermined direction, as the correction to shift the arrangement positions of the plurality of articles.

[29]

The article selection system according to any one of [25] to [28],

wherein the display controller disposes the plurality of articles at equal intervals and displays the articles on the display unit, on the basis of the number of plurality of articles, and

the corrector determines the amount of correction on the basis of the amount of change and the number of articles.

[30]

The article selection system according to any one of [25] to [29],

wherein the display controller displays the plurality of articles disposed along a circumferential direction based on the reference position on the display unit, and

the corrector performs at least one of correction of the indicating direction in a clockwise or counterclockwise direction based on the reference position and correction to shift the arrangement positions of the plurality of articles in the clockwise or counterclockwise direction, in accordance with the amount of correction.

[31]

The article selection system according to any one of [25] to [30],

wherein the display controller displays an indicating image for specifying the indicating direction on the display unit in a case where the amount of tilting is equal to or greater than the predetermined threshold value.

[32]

The article selection system according to any one of [25] to [31],

wherein the display controller displays the article in a display mode for specifying the article indicated by the indicating direction in a case where the amount of tilting is equal to or greater than the predetermined threshold value.

[33]

The article selection system according to any one of [25] to [32],

wherein the display controller displays the article by an icon image capable of specifying contents of the article.

[34]

The article selection system according to any one of [25] to [33],

wherein the operation unit includes an operation stick which is capable of being tilted in any direction and returns to an erected state by cancelling the tilting.

[35]

The article selection system according to any one of [25] to [34], further including:

a controller that controls a motion of a player object in a game space on the basis of the operation information of the operation unit to control progress of a video game and causes the player object to perform a motion associated with the article selected from among the plurality of articles.

[36]

A terminal device that receives operation information of an operation unit tilted in any direction and selects one article from among a plurality of articles displayed on a display unit on the basis of the operation information, the terminal device including:

a display controller that displays the plurality of articles, which are disposed along a predetermined direction with respect to a reference position in a screen coordinate system of the display unit, on the display unit;

a direction determiner that determines an indicating direction indicating the one article from the reference position, on the basis of a tilting direction of the operation unit which is included in the operation information in a case where an amount of tilting of the operation unit which is included in the operation information is less than the predetermined threshold value;

a corrector that determines an amount of correction on the basis of an amount of change in the tilting direction based on the tilting direction at a time of the determination of the indicating direction in a case where the amount of tilting is equal to or greater than the predetermined threshold value, and performs at least one of correction of the indicating direction and correction to shift arrangement positions of the plurality of articles along the predetermined direction in accordance with the amount of correction; and

a selector that selects an article indicated by the indicating direction in a case where the amount of tilting is equal to or greater than the predetermined threshold value.

[37]

An article selection method of causing a computer to receive operation information of an operation unit tilted in any direction and select one article from among a plurality of articles displayed on a display unit on the basis of the operation information, the article selection method including:

a display control process of displaying the plurality of articles, which are disposed along a predetermined direction with respect to a reference position in a screen coordinate system of the display unit, on the display unit;

a direction determination process of determining an indicating direction indicating the one article from the reference position, on the basis of a tilting direction of the operation unit which is included in the operation information in a case where an amount of tilting of the operation unit which is included in the operation information is less than the predetermined threshold value;

a correction process of determining an amount of correction on the basis of an amount of change in the tilting direction based on the tilting direction at a time of the determination of the indicating direction in a case where the amount of tilting is equal to or greater than the predetermined threshold value, and performing at least one of correction of the indicating direction and correction to shift arrangement positions of the plurality of articles along the predetermined direction in accordance with the amount of correction; and

a selection process of selecting an article indicated by the indicating direction in a case where the amount of tilting is equal to or greater than the predetermined threshold value.

According to one of the embodiments of the present invention, the present invention is useful to provide a function of improving user operability in selecting an article using a tilting operation of an operation unit.

What is claimed is:

1. A program causing a computer to realize a function of receiving operation information of an operation unit tilted in any direction and selecting one article from among a plurality of articles displayed on a display unit on the basis of the operation information, the program causing the computer to execute:
a display control function of displaying the plurality of articles, which are disposed along a predetermined direction with respect to a reference position in a screen coordinate system of the display unit, on the display unit;
a direction determination function of determining an indicating direction indicating the one article from the reference position, on the basis of a tilting direction of the operation unit which is included in the operation information in a case where an amount of tilting of the operation unit which is included in the operation information is less than the predetermined threshold value;
a correction function of determining an amount of correction on the basis of an amount of change in the tilting direction based on the tilting direction at a time of the determination of the indicating direction in a case where the amount of tilting is equal to or greater than the predetermined threshold value, and performing at least one of correction of the indicating direction and correction to shift arrangement positions of the plurality of articles along the predetermined direction in accordance with the amount of correction; and
a selection function of selecting an article indicated by the indicating direction in a case where the amount of tilting is equal to or greater than the predetermined threshold value.

2. The program according to claim 1, causing the computer to further execute:
a region setting function of setting separate regions obtained by dividing a range capable of being indicated from the reference position in the predetermined direction, and associating one of the plurality of articles with each of the separate regions,
wherein the display control function realizes a function of displaying the article associated with a position corresponding to each of the separate regions, and
the selection function realizes a function of selecting the article associated with the separate region including the indicating direction.

3. The program according to claim 2,
wherein the display control function realizes a function of disposing the article associated with the separate region on a central direction which is a direction passing through a center of the separate region from the reference position and displaying the article on the display unit,
wherein the direction determination function realizes a function of determining any one of the central directions of the respective separate regions to be the indicating direction on the basis of the tilting direction, and
the correction function realizes a function of correcting the determined indicating direction to any one of the central directions of the respective separate regions, as the correction of the indicating direction.

4. The program according to claim 2,
wherein the display control function realizes a function of disposing the article associated with the separate region on a central direction which is a direction passing through a center of the separate region from the reference position and displaying the article on the display unit,
the direction determination function realizes a function of determining any one of the central directions of the respective separate regions to be the indicating direction on the basis of the tilting direction, and
the correction function realizes a function of shifting the arrangement positions of the plurality of articles on any one of the central directions of the respective separate regions along the predetermined direction, as the correction to shift the arrangement positions of the plurality of articles.

5. The program according to claim 1,
wherein the display control function realizes a function of disposing the plurality of articles at equal intervals and displaying the articles on the display unit, on the basis of the number of plurality of articles, and
the correction function realizes a function of determining the amount of correction on the basis of the amount of change and the number of articles.

6. The program according to claim 1,
wherein the display control function realizes a function of displaying the plurality of articles disposed along a circumferential direction based on the reference position on the display unit, and
the correction function realizes a function of performing at least one of correction of the indicating direction in a clockwise or counterclockwise direction based on the reference position and correction to shift the arrangement positions of the plurality of articles in the clockwise or counterclockwise direction, in accordance with the amount of correction.

7. The program according to claim 1,
wherein the display control function realizes a function of displaying an indicating image for specifying the indicating direction on the display unit in a case where the amount of tilting is equal to or greater than the predetermined threshold value.

8. The program according to claim 1,
wherein the display control function realizes a function of displaying the article in a display mode for specifying the article indicated by the indicating direction in a case where the amount of tilting is equal to or greater than the predetermined threshold value.

9. The program according to claim 1,
wherein the display control function realizes a function of displaying the article by an icon image capable of specifying contents of the article.

10. The program according to claim 1,
wherein the operation unit includes an operation stick which is capable of being tilted in any direction and returns to an erected state by cancelling the tilting.

11. The program according to claim 1, causing the computer to further execute:
a function of controlling a motion of a player object in a game space on the basis of the operation information of the operation unit to control progress of a video game and causing the player object to perform a motion associated with the article selected from among the plurality of articles.

12. A program causing a server device to select one article from among a plurality of articles displayed on a display unit of a terminal device on the basis of operation information of an operation unit tilted in any direction, the server device being connected to the terminal device receiving the operation information through a communication network, the program causing the server device to execute:
a display control function of displaying the plurality of articles, which are disposed along a predetermined direction with respect to a reference position in a screen coordinate system of the display unit, on the display unit;
a direction determination function of determining an indicating direction indicating the one article from the reference position, on the basis of a tilting direction of the operation unit which is included in the operation information in a case where an amount of tilting of the operation unit which is included in the operation information is less than the predetermined threshold value;
a correction function of determining an amount of correction on the basis of an amount of change in the tilting direction based on the tilting direction at a time of the determination of the indicating direction in a case where the amount of tilting is equal to or greater than the predetermined threshold value, and performing at least one of correction of the indicating direction and correction to shift arrangement positions of the plurality of articles along the predetermined direction in accordance with the amount of correction; and
a selection function of selecting an article indicated by the indicating direction in a case where the amount of tilting is equal to or greater than the predetermined threshold value.

13. An article selection system including a terminal device that receives operation information of an operation unit tilted in any direction and a server device, connected to the terminal device through a communication network, which selects one article from among a plurality of articles displayed on a display unit of the terminal device on the basis of the operation information, the article selection system comprising:
a display controller that display the plurality of articles, which are disposed along a predetermined direction with respect to a reference position in a screen coordinate system of the display unit, on the display unit;
a direction determiner that determines an indicating direction indicating the one article from the reference position, on the basis of a tilting direction of the operation unit which is included in the operation information in a case where an amount of tilting of the operation unit which is included in the operation information is less than the predetermined threshold value;
a corrector that determines an amount of correction on the basis of an amount of change in the tilting direction based on the tilting direction at a time of the determination of the indicating direction in a case where the amount of tilting is equal to or greater than the predetermined threshold value, and performing at least one of correction of the indicating direction and correction to shift arrangement positions of the plurality of articles along the predetermined direction in accordance with the amount of correction; and
a selector that selects an article indicated by the indicating direction in a case where the amount of tilting is equal to or greater than the predetermined threshold value.

14. A terminal device that receives operation information of an operation unit tilted in any direction and selects one article from among a plurality of articles displayed on a display unit on the basis of the operation information, the terminal device including:
a display controller that displays the plurality of articles, which are disposed along a predetermined direction with respect to a reference position in a screen coordinate system of the display unit, on the display unit;
a direction determiner that determines an indicating direction indicating the one article from the reference position, on the basis of a tilting direction of the operation unit which is included in the operation information in a case where an amount of tilting of the operation unit which is included in the operation information is less than the predetermined threshold value;
a corrector that determines an amount of correction on the basis of an amount of change in the tilting direction based on the tilting direction at a time of the determination of the indicating direction in a case where the amount of tilting is equal to or greater than the predetermined threshold value, and performs at least one of correction of the indicating direction and correction to shift arrangement positions of the plurality of articles along the predetermined direction in accordance with the amount of correction; and
a selector that selects an article indicated by the indicating direction in a case where the amount of tilting is equal to or greater than the predetermined threshold value.

15. An article selection method of causing a computer to receive operation information of an operation unit tilted in any direction and select one article from among a plurality of articles displayed on a display unit on the basis of the operation information, the article selection method including:
a display control process of displaying the plurality of articles, which are disposed along a predetermined direction with respect to a reference position in a screen coordinate system of the display unit, on the display unit;
a direction determination process of determining an indicating direction indicating the one article from the reference position, on the basis of a tilting direction of the operation unit which is included in the operation information in a case where an amount of tilting of the operation unit which is included in the operation information is less than the predetermined threshold value;
a correction process of determining an amount of correction on the basis of an amount of change in the tilting direction based on the tilting direction at a time of the determination of the indicating direction in a case where the amount of tilting is equal to or greater than the predetermined threshold value, and performing at least one of correction of the indicating direction and correction to shift arrangement positions of the plurality of articles along the predetermined direction in accordance with the amount of correction; and
a selection process of selecting an article indicated by the indicating direction in a case where the amount of tilting is equal to or greater than the predetermined threshold value.
